(19) United States
(12) Patent Application Publication
(10) Pub. No.: US 2022/0083683 A1
(43) Pub. Date: Mar. 17, 2022

(54) DISTRIBUTED SELF-GOVERNING COMPUTER NETWORK TO CORRELATE BLOCKCHAIN AND PRIVATE COMPUTER SYSTEM TRANSACTIONS METHOD, APPARATUS, AND SYSTEM

(71) Applicant: Transparent Financial Systems, Inc., Seattle, WA (US)

(72) Inventors: Patrick Murck, Lexington, MA (US); Kataryna F. Gray, Seattle, WA (US); Jeffrey A. Kramer, Redmond, WA (US)

(73) Assignee: Transparent Financial Systems, Inc., Seattle, WA (US)

(21) Appl. No.: 17/474,044

(22) Filed: Sep. 13, 2021

Related U.S. Application Data
(60) Provisional application No. 63/077,400, filed on Sep. 11, 2020.

(51) Int. Cl. G06F 21/62; H04L 9/32; H04L 9/30; H04L 9/00; G06Q 20/38; G06Q 40/02; G06Q 20/02; A63F 13/792

(52) U.S. Cl. CPC G06F 21/6227; H04L 9/3255; H04L 9/30; H04L 9/008; G06Q 20/389; G06F 16/27; G06Q 20/02; A63F 13/792; H04L 2209/38; H04L 2209/16; G06Q 2230/00; G06Q 40/02

(57) ABSTRACT

Methods, apparatus, and system to create and maintain a permissioned, proof-of-authority distributed blockchain computer system which can correlate transactions on the distributed blockchain computer system with transactions in a private computer system, such that objects transferable in the private computer system can be transferred with greater speed, efficiency, and transparency using distributed blockchain computer system than when transferred solely using the private computer system, such that parties which provide the distributed blockchain computer system, who provide services to the distributed blockchain computer system, and who use the distributed blockchain computer system are compensated, and such that nodes creating the distributed blockchain computer system, members obtaining services from the distributed blockchain computer system, and services providers to the distributed blockchain computer system can govern the distributed blockchain computer system and ensure its operation with a reasonable amount of communication.

### FIELD

The present disclosure relates to a distributed computer system, in particular to, a distributed self-governing computer system to correlate transactions on a blockchain computer system with transactions on a private computer system.

### BACKGROUND

Humans and computer systems have many mediums of exchange. For example, fiat money is a medium of exchange. Other examples include “points” earned in loyalty rewards systems, such as for flying on airlines, purchasing groceries. Other examples include “points” earned for playing computer games. Other examples include “book credits” which can be earned for lending books and which can be used to request that others lend a party a book, without a one-to-one exchange. Other examples include digital goods, such as software licenses, subscriptions to use software, digital clothing for avatars, digital weapons or tools used in computer games, and the like. Other examples include insurance premium payouts and other contractual rights and obligations. In many cases, these objects or digital representations of them can be transferred between users of a private computer system or even between private computer systems which agree to work together.

Fiat money is a medium of exchange which does not have intrinsic value and does not have a use value; fiat money in a particular jurisdiction (e.g. US Dollar, Canadian Dollar, Euro, Pound, Yuan, etc.), also known as a “fiat currency”, has value only because a government of the jurisdiction requires or accepts use of the fiat currency to pay debts not settled through other means. The supply of fiat currency of a jurisdiction is typically centrally controlled by the government of the jurisdiction and the government may also control or influence interest rates, e.g. by controlling short term interest rates charged by the government to commercial banks.

Traditionally, commercial banks accept deposits of fiat currency from depositors, hold at least a portion of deposited fiat currency in vaults, lend currency to debtors, and maintain accounts for themselves, depositors, and debtors. Before the development of private computer systems, accounts were kept in paper ledgers, privately maintained, which recorded amounts of fiat currency (or other items with value) deposited by depositors or lent to debtors. Various contractual and legal traditions were developed, e.g. securities, commercial paper, etc. to represent amounts of fiat currency, obligations with respect to fiat currency, and to facilitate the exchange of currency through changes to accounts on the private ledgers, without necessarily requiring exchange of fiat currency.

Exchange of fiat currency through changes to accounts often involved one or more intermediaries, e.g. settlement networks, government banks, etc. Settlement of accounts often occurs at a speed determined by the intermediaries, by laws of the jurisdiction, and with additional costs imposed by the intermediaries. Exchange of fiat currency through changes to accounts in private ledgers produces errors, which must be reversed through slow manual processes performed by humans. Currently, payments between individuals and businesses settled using fiat currency in the United States require one to three days, settlements may occur only in banking hours, and numerous fees may be charged by banks and intermediaries. Similar costs and latencies occur with respect to other mediums of exchange, such as insurance premium payouts and other contractual rights and obligations.

With the advent of computer game systems, users wanted to exchange credits with other users and to exchange credits earned in a first game for credits in a second game system. This desire, and lack of trust between operators of the game systems and participants, lead to the development of distributed ledgers. Distributed ledgers are databases, datastores, or information repositories maintained by a plurality of nodes in a peer-to-peer computer network, with no central authority, using a consensus algorithm. Each node maintains a fully copy of the distributed ledger; when the distributed ledger is updated by a first node, the first node lets other nodes know, the nodes construct the new transaction, and the nodes vote according to the consensus algorithm regarding which node's version of the new, updated, distributed ledger is correct. Once a consensus is determined, all of the nodes update themselves with the new, “correct” version of the ledger. The consensus algorithm generally uses cryptographic keys to tie blocks of data in the “correct” distributed ledger together and in a sequential order, so that later blocks comprise a cryptographic hash value derived from earlier blocks. Such a series of blocks is sometimes referred to as a Merkle tree.

Blockchain computer systems (defined further herein) are a form of distributed ledger to create and transfer cryptocurrencies in transactions. In a well-known blockchain, the Bitcoin blockchain, nodes may “mine” bitcoin (“BTC”) by performing a mathematical problem which requires “brute force” computational resources (“proof of work”). A node which is first to discover the next solution of the mathematical problem is rewarded with a BTC. Nodes also group transactions, record them on the Bitcoin blockchain in new blocks, and charge transactions fees for these services, which are paid in BTC. The total supply of BTC which may be mined is limited to a fixed number by the consensus algorithm of the Bitcoin blockchain. It is sometimes noted that the Bitcoin blockchain is not a true computer system because it cannot store the equivalent of software modules in memory but can only acts as a datastore. Another well-known blockchain, the Ethereum blockchain, uses “ETH” as its cryptocurrency, presently uses a proof of work process to mine ETH (though is scheduled to adopt a “proof of stake” process), allows storage of “smart contracts” (defined further herein, though generally may be understood as software modules in memory), and charges transaction fees which are paid in ETH. The total supply of ETH may increase indefinitely, e.g. the supply of ETH is inflationary, though the consensus algorithm has recently changed to result in “burning” of ETH during transactions, which may reduce or eliminate inflation in the supply of ETH.

As computer systems, distributed blockchain computer systems are thousands of times slower and more expensive to operate than private computer systems; this is because distributed blockchain computer systems are not provided by one physically integrated computer system but are provided by numerous separate computer systems which must communicate across a network, such as the Internet, and which do not inherently trust one another and must follow a consensus algorithm to update the datastore of the distributed blockchain computer system and to (virtually) perform the functions of a (virtual) processor of the distributed blockchain computer system.

Though expensive and slow, distributed blockchain computer systems make possible “trustless scarcity models”. A scarcity model is a representation of a finite resource, such a chairs or tables in a restaurant. If a receptionist keeps a spreadsheet of reservations for one hundred chairs in a restaurant, the spreadsheet is a scarcity model representing the finite resource. The receptionist may notice that only ninety-eight or ninety-nine people ever show up, even if all chairs are reserved. The receptionist may then start to oversubscribe the scarcity model, taking one-hundred and two reservations. On a night when one-hundred and one or one-hundred and two people show up, the additional one or two people will realize that there was a “scarcity model” maintained by the receptionist and that they mistakenly trusted the receptionist's scarcity model. A trustless scarcity model would be kept in public, such that the people making the reservations could see the number of chairs and the number of reservations (or at least whether the chairs were oversubscribed). Distributed blockchain computer systems make possible “trustless scarcity models”, wherein everyone can see its functions, numbers or units held in memory, can validate the operations performed by the functions, the numbers or units processed by the functions, and the output of the functions.

Private computer systems allow system administrators to see functions, operations performed by functions, numbers or units processed by the functions, and output thereof; however, private computer systems also allow system administrators to change all past records of the private computer systems. In contrast, distributed blockchains cryptographically ensure that all past records, or a product of them, are preserved in future records. The consensus algorithms in distributed blockchain computer systems are typically designed to create incentives for a majority of blockchain nodes to follow the rules, including rules which enforce use of a cryptocurrency as the unit used to pay for execution of the blockchain computer system.

Private computer systems which keep private ledgers fundamentally cannot be trusted, except by those who have administrative access to the private computer systems. Fundamentally, the private nature of private ledgers in private banks leads to complexities, costs, and time delays in conventional settlement systems which underlie traditional exchange networks for fiat currencies.

In overview, cryptocurrencies, such as BTC and ETH, differ from fiat currencies in that the ledgers which record transactions involving these cryptocurrencies are public distributed ledgers or datastores maintained on distributed blockchain computer systems, rather than private ledgers maintained on private computer systems. In addition, these cryptocurrencies have a use value, inasmuch as the cryptocurrencies are used to pay fees required to operate the corresponding blockchain computer systems and inasmuch as the corresponding blockchain computer systems can provide services, such as implementation of trustless scarcity models. Though distributed blockchain computer systems are slower and more expensive to operate than private computer systems, they make possible services such as implementation of trustless scarcity models, which cannot be provided using private computer systems; these trustless scarcity models allow automated settlement of financial transactions in ways that are not possible using private computer systems.

Though distributed blockchain computer systems can perform functions on the blockchain in a “trustless” manner (trust is shifted to the consensus algorithm and that a majority of nodes will follow the rules of the consensus algorithm), both private computer systems and public blockchain computer systems cannot import data from outside of the computer system without raising issues of trust in the imported data. For example, a smart contract in a distributed blockchain computer system may be designed to implement a futures market for a commodity, wherein participants invest in tokens which reflect a higher or lower future price of the commodity on a future date. Because the smart contract for the futures contract is built on a distributed blockchain computer system, information such as the logic of functions in the smart contract, the number of participants, the number and size of investments, and payouts can all be seen. When the future date arrives, a price of the commodity is input into the smart contract and the smart contract will programmatically payout tokens reflecting the logic of the functions, and the like, all without relying on trust (except in the consensus algorithm for the distribute blockchain computer system). However, input of the price of the commodity does rely on trust, as input into sensors of the distributed blockchain computer system is not “native” and may be manipulated.

Correlating transactions in a distributed blockchain computer with transactions in private computer systems is a hard and persistent problem.

Needed is a distributed blockchain computer system which can correlate transactions on the distributed blockchain computer system with transactions in a private computer system, such that objects transferable in the private computer system can be transferred with greater speed, efficiency, and transparency on the distributed blockchain computer system than in the private computer system, such that parties who provide the distributed blockchain computer system and who provide services to the distributed blockchain computer system are compensated, and such that nodes creating the distributed blockchain computer system, members obtaining services from the distributed blockchain computer system, and services providers to the distributed blockchain computer system can govern the distributed blockchain computer system with a reasonable amount of communication.

### BRIEF DESCRIPTION OF THE DRAWINGS

FIG. 1 is a network and device diagram illustrating an example of an XAND blockchain creation computer system, XAND blockchain creation computer system datastore, a blockchain node, an XAND blockchain computer system, a participating private computer system, a participating private computer system datastore, a trustee computer system, a trustee computer system datastore, a member computer system, a member computer system datastore, and a network incorporated with teachings of the present disclosure, according to some embodiments.

FIG. 2 is a functional block diagram illustrating an example of a computer device, as found in several of the computer systems of FIG. 1, incorporated with teachings of the present disclosure, according to some embodiments.

FIG. 3 is a functional block diagram illustrating an example of a computer device datastore, as found in several of the computer systems of FIG. 1, incorporated with teachings of the present disclosure, consistent with embodiments of the present disclosure.

FIG. 4 is a flow diagram illustrating an example of a method performed by a blockchain execution module, incorporated with teachings of the present disclosure, consistent with embodiments of the present disclosure.

FIG. 5 is a flow diagram illustrating an example of a method performed by a governance module, incorporated with teachings of the present disclosure, consistent with embodiments of the present disclosure.

FIG. 6 is a flow diagram illustrating an example of a method performed by a system transaction module, incorporated with teachings of the present disclosure, consistent with embodiments of the present disclosure.

FIG. 7 is a flow diagram illustrating an example of a method performed by a member blockchain module, incorporated with teachings of the present disclosure, consistent with embodiments of the present disclosure.

FIG. 8 is a flow diagram illustrating an example of a method performed by a create correlated blockchain transferable record module, incorporated with teachings of the present disclosure, consistent with embodiments of the present disclosure.

FIG. 9 is a flow diagram illustrating an example of a method performed by a transfer all or part of a correlated blockchain transferable record module, incorporated with teachings of the present disclosure, consistent with embodiments of the present disclosure.

FIG. 10 is a flow diagram illustrating an example of a method performed by a redeem all or part of a correlated blockchain transferable record module, incorporated with teachings of the present disclosure, consistent with embodiments of the present disclosure.

FIG. 11 is a flow diagram illustrating an example of a method performed by a trustee blockchain module, incorporated with teachings of the present disclosure, consistent with embodiments of the present disclosure.

FIG. 12 is a flow diagram illustrating an example of a method performed by a confirm transfer module, incorporated with teachings of the present disclosure, consistent with embodiments of the present disclosure.

FIG. 13 is a flow diagram illustrating an example of a method performed by a transfer object transferable between user of private computer system from trust account to member, verifier, or trustee account module, incorporated with teachings of the present disclosure, consistent with embodiments of the present disclosure.

FIG. 14 is a flow diagram illustrating an example of a method performed by an excess disbursement module, incorporated with teachings of the present disclosure, consistent with embodiments of the present disclosure.

### DETAILED DESCRIPTION

In addition to other locations, defined terms may be found at the end of this Detailed Description.

In overview, this disclosure relates to an apparatus and methods performed by and in a plurality of computer device apparatuses 105 (also referred to herein as, “blockchain nodes”) to execute blockchain execution module 400. In overview, when executed, blockchain execution module 400 creates one or more distributed, self-governing blockchain computer system 130 (also referred to herein as an “XAND blockchain computer system 130”), by performing governance module 500 and system transaction module 600.

XAND blockchain computer system 130 may be a proof-of-authority blockchain computer system. Proof-of-authority may be used because it is less expensive than a proof-of-work blockchain and because proof-of-stake may be ineffective for a blockchain computer system wherein blockchain-transferable records correspond to private computer system user transferable objects, which have value external to the blockchain computer system. In proof-of-stake blockchain computer systems which generate the tokens or cryptocurrency required to operate the network, nodes have a disincentive to attack the blockchain computer system, because doing so will drive the value of the tokens to zero. In the proof-of-authority XAND blockchain computer system 130, attack of the network by non-functioning blockchain nodes results in loss of revenue and removal from XAND blockchain computer system 130.

When executed, governance module 500 may allow an operator of member computer system 150 (also referred to herein as a “member”) to execute member module 700 and join XAND blockchain computer system 130. When executed, governance module 500 may allow an operator of trustee computer system 140 (also referred to herein as a “trustee”) to execute trustee module 1100 and join XAND blockchain computer system 130.

Governance module 500 may allow blockchain nodes 105 and instances of member module 700 to adopt and modify system software 136, such as blockchain execution module 400, member module 700, and trustee module 1100, as described further herein.

Adoption and modification of system software 136, such as trustee module 1100 or records used thereby, may set or modify a level of buffer accounts at private computer system 120 which trustee module 1100 is to maintain, wherein trustee module 1100 may use said buffer accounts to address latency in transfer of private computer system user transferable objects between users across a plurality of private computer systems. Private computer system user transferable objects may comprise, for example, computer system game points, digital goods (such as software licenses, subscriptions to use software, digital clothing for avatars, digital weapons or tools used in computer games, and the like), loyalty points, contractual rights and obligations, fiat currency, or the like.

Adoption and modification of system software 136, such as blockchain execution module 400 or trustee module 1100 or records used thereby, may set or modify an amount of compensation paid to one or more of blockchain execution module 400, member module 700, and trustee module 1100, wherein the compensation may be paid in creation of one or more blockchain-transferable record redeemable for a private computer system user transferable object. For example, when blockchain node 105 commits a block to Merkle tree 137, blockchain node 105 may be rewarded with a blockchain-transferable record which is redeemable for an amount of a private computer system user transferable object.

Adoption and modification of system software 136, such as trustee module 1100, may set or modify a threshold at which trustee module 1100 may transfer to one or more of blockchain execution module 400, member module 700, or trustee module 1100 any excess which may have accumulated in accounts of trustee module 1100 at private computer system 120, for example, due to interest or deflation in loyalty point value.

System transaction module 600 may allow blockchain node 105 to process proposed transaction records to be included in a block in Merkle tree 137, such as to create blockchain-transferable records corresponding to private computer system user transferable objects 138.

System transaction module 600 may allow blockchain node 105 and member module 700 to identify equivocation among blockchain nodes 105 performing a consensus vote to validate proposed blocks, such as an incipient fork in Merkle tree 137. Blockchain nodes 105 identified to have been nonperforming may be nominated for removal to governance module 500, resulting in loss of compensation. In this way, nonperforming blockchain nodes 105 may have an incentive not to validate proposed blocks which are malformed or malicious.

System transaction module 600 may allow blockchain node 105 to commit or finalize a then-current state of Merkle tree 137 of blocks in XAND blockchain computer system datastore 131.

Member module 700 may obtain a view of XAND blockchain computer system 130, may allow a party operating member module 700 to vote with respect to issues raised before governance module 500, may execute create correlated blockchain-transferable record module 800, may execute transfer all or part of correlated blockchain transferable record module 900, and or may execute redeem all or part of correlated blockchain transferable record module 1000.

Trustee module 1100 may obtain a view of XAND blockchain computer system 130, execute confirm transfer module 1200, execute transfer private computer system user transferable object from trust account to member module, blockchain node, or trustee account module 1300, and or may execute excess disbursement module 1400.

In this manner, blockchain execution module 400, member module 700, and trustee module 1100 may create a permissioned, proof-of-authority XAND blockchain computer system 130. In this manner, governance module 500 may allow participants in the XAND blockchain computer system 130 to govern XAND blockchain computer system 130, including addition or removal of one or more blockchain node 105, including addition or removal of one or more member module 700, including addition or removal of one or more trustee module 1100, including addition or removal of one or more private computer system 120 with which XAND blockchain computer system 130 and system software 136 operates, including modification of system software 136.

Modification of system software 136 may comprise modification of a level of buffer accounts at private computer system 120 which trustee module 1100 is to maintain, wherein trustee module 1100 may use said buffer accounts to address latency in transfer of private computer system user transferable objects between users among a plurality of private computer systems. Modification of system software 136 may comprise modification of an amount of compensation paid to one or more of blockchain execution module 400, member module 700, and trustee module 1100, wherein the compensation may be paid in creation of one or more blockchain-transferable record redeemable for a private computer system user transferable object. Modification of system software 136 may comprise modification of a threshold at which trustee module 1100 may transfer to one or more of blockchain execution module 400, member module 700, or trustee module 1100 any excess which may have accumulated in accounts of trustee module 1100 at private computer system 120, for example, due to interest or deflation in loyalty point value.

In this manner, a first member module 700A may transfer a first private computer system user transferable object 123A from a first private computer system member user account 125A of first member module 700A at private computer system 120 to a first private computer system trustee user account 124A of trustee module 1100 at a first private computer system 120A and request creation of blockchain-transferable record corresponding to private computer system user transferable object 138 at a first address in XAND blockchain computer system datastore 131 under control of first member module 700A. In this manner, trustee module 1100 may confirm transfer of the first private computer system user transferable object 123A from first private computer system member user account 125A of first member module 700A at first private computer system 120A to a first private computer system trustee user account 124A of trustee module 1100 at first private computer system 120A. In this manner a plurality of blockchain nodes and blockchain execution modules 400 may verify and commit the requested blockchain-transferable record corresponding to private computer system user transferable object 138 as an immutable record in a block of Merkle tree 137 at a first address in XAND blockchain computer system datastore 131 under control of first member module 700A.

In this manner, first member module 700A may request transfer of the blockchain-transferable record corresponding to private computer system user transferable object 138 from the first address in XAND blockchain computer system datastore 131 under control of first member module 700A to a second address in XAND blockchain computer system datastore 131 under control of a second member module 700B. In this manner, the plurality of blockchain nodes and blockchain execution modules 400 may verify and commit the requested transfer to a block in XAND blockchain computer system datastore 131. In this manner, second member module 700B may request redemption of the blockchain-transferable record corresponding to private computer system user transferable object 138. In this manner, the plurality of blockchain execution modules 400 may verify and commit the redemption request of second member module 700B to XAND blockchain computer system datastore 131, trustee module 1100 may transfer the first private computer system user transferable object 123A from first private computer system trustee user account 124A at first private computer system 120A or may transfer a second private computer system user transferable object 123B from second private computer system trustee user account 124B at second private computer system 120B to second private computer system member user account 125B at first private computer system 120A or at second private computer system 120B such that second member module 700B controls the first private computer system user transferable object 123A or the second private computer system user transferable object 123B.

In this manner, trustee module 1100 may maintain and balance first private computer system trustee user account 124A at first private computer system 120A and second private computer system trustee user account 124B at second private computer system 120B, according to rules set in system software 136.

In this manner, trustee module 1100 may disburse excess private computer system user transferable objects 123, as may result from interest or deflation of loyalty points, to one or more of blockchain node 105, member module 700, or trustee module 1100, by disbursement of blockchain-transferable record corresponding to private computer system user transferable object 138.

In this manner, identity of parties initiating transfers or receiving transfers may be concealed through identify tags constructed from public keys of such parties and through use of correlation tags. In this manner, amounts of a transfer may be concealed through homomorphic representation, wherein the homomorphic representation allows the concealed amounts to be added or subtracted.

In this manner, methods, apparatus, and system are disclosed to create and maintain a permissioned, proof-of-authority distributed blockchain computer system which can correlate transactions on the distributed blockchain computer system with transactions in a private computer system, such that objects transferable in the private computer system can be transferred with greater speed, efficiency, and transparency using distributed blockchain computer system than when transferred solely using the private computer system, such that parties which provide the distributed blockchain computer system, who provide services to the distributed blockchain computer system, and who use the distributed blockchain computer system are compensated, and such that nodes creating the distributed blockchain computer system, members obtaining services from the distributed blockchain computer system, and services providers to the distributed blockchain computer system can govern the distributed blockchain computer system and ensure its operation with a reasonable amount of communication.

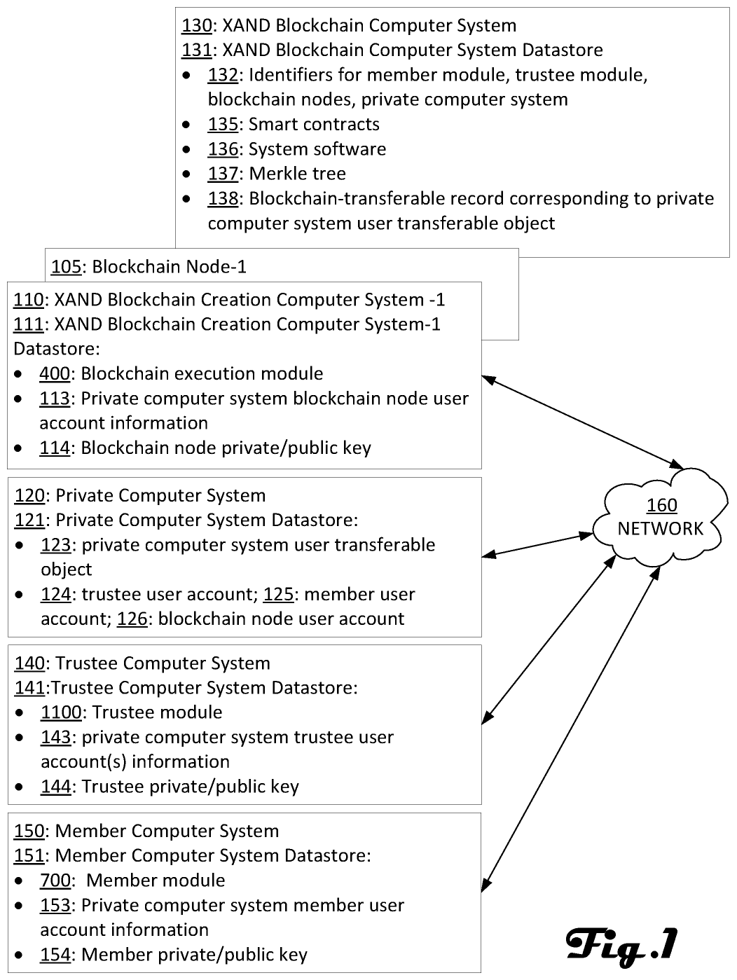

FIG. 1 is a network and device diagram illustrating an example of XAND blockchain creation computer system 110, XAND blockchain creation computer system datastore 111, blockchain node 105, XAND blockchain computer system 130, XAND blockchain computer system datastore 131, private computer system 120, private computer system datastore 121, trustee computer system 140, trustee computer system datastore 141, member computer system 150, member computer system datastore 151, and network 160 incorporated with teachings of the present disclosure, according to some embodiments.

XAND blockchain creation computer system 110 may represent a plurality of such computer systems. XAND blockchain creation computer system 110 may be a computer system similar to computer system 200, comprising XAND blockchain creation computer system datastore 111 similar to computer system datastore 300. XAND blockchain creation computer system datastore 111 may comprise blockchain execution module 400 as well as, for example, private computer system blockchain node user account information 113 and blockchain node private/public key 114. Blockchain execution module 400 may be executed by a computer processor of XAND blockchain creation computer system 110 to operate blockchain node 105 and to create and manage XAND blockchain computer system 130 and to provide the services discussed herein.

Private computer system blockchain node user account information 113 may be used to login to private computer system blockchain node user account 126 at private computer system 120 and may be used to receive private computer system user transferable object 123, such as to compensate a party for operating blockchain execution module 400. Blockchain node private/public key 114 may be used to attest to the identity of an instance of blockchain module 400.

XAND blockchain computer system 130 may be a distributed, permissioned, proof-of-authority blockchain computer system similar to computer system 200, comprising XAND blockchain computer system datastore 131 similar to computer system datastore 300 and comprising a processor, though as implemented in a distributed, virtualized, manner, e.g. where a plurality of blockchain nodes 105 provide XAND blockchain computer system 130, XAND blockchain computer system datastore 131, and the processor of XAND blockchain computer system 130 in a virtualized manner. In addition to blockchain nodes 105, which may have full access to XAND blockchain computer system datastore 131 and which may provide processing services to create the processor for XAND blockchain computer system 130, parties such as member module 700 and trustee module 1100 may have view access to XAND blockchain computer system datastore 131.

XAND blockchain computer system datastore 131 may comprise modules, programs, or processes in memory for execution by the processor of XAND blockchain computer system 130, also referred to as “smart contracts 135”. Smart contracts 135 may comprise, for example, modules to interface with and provide services to one or more of blockchain execution module 400, member module 700, and trustee module 1100. Such services may provide, for example, round-robin communication methodologies among blockchain execution module 400 instances, identity confirmation processes, numerical concealment processes, cryptographic proof processes, blockchain creation and maintenance processes, and the like.

XAND blockchain computer system datastore 131 may comprise addresses controlled by modules, such as controlled by one or more blockchain nodes 105, member modules 700, trustee modules 1100. Some or all of blocks in Merkle tree 137 may be stored at one or more of such addresses.

XAND blockchain computer system datastore 131 may comprise system software 136, as discussed herein. System software 136 may be executed by a computer processor of XAND blockchain computer system 130 and or may be downloaded to or accessed by one or more of XAND blockchain creation computer system 110, trustee computer system 140, and or member computer system 150.

XAND blockchain computer system datastore 131 may comprise Merkle tree 137 comprising blocks stored at one or more addresses in XAND blockchain computer system datastore 131.

XAND blockchain computer system datastore 131 and addresses therein may comprise one or more blockchain-transferable record corresponding to private computer system user transferable object 138, as discussed herein.

Private computer system 120 may comprise a computer system of, for example, a game company, a software company, a bank, a loyalty program, a financial services company, or the like. Private computer system 120 may be similar to computer system 200. Private computer system datastore 121 may be a datastore of private computer system 120 and may be similar to computer system datastore 300.

Private computer system datastore 121 may comprise one or more user account, such as trustee user account 124, member user account 125, blockchain node user account 126, wherein such user account may be used by a user to interact with and obtain services from private computer system 120. User accounts may comprise or be associated with private computer system user transferable object 123. Private computer system user transferable object 123 may comprise or refer to a digital object, such as a game point or credit, a computer software program, a subscription, a loyalty point or credit, a representation of fiat money, a contractual right or obligation, a cryptocurrency, or the like, wherein the private computer system user transferable object 123 may be transferable between users of private computer system 120, between a plurality of instances of private computer system 120 operated by a same party, or between instances of private computer system 120 operated by different parties who agree to transfer private computer system user transferable objects 123, such as game points, fiat money, or the like, between them.

Trustee computer system 140 may be a computer system similar to computer system 200. Trustee computer system 140 may comprise trustee computer system datastore 141 similar to computer system datastore 300. Trustee computer system datastore 141 may comprise trustee module 1100 as well as, for example, one or more private computer system trustee user account(s) information 143, and trustee private/public key 144. Trustee module 1100 may be executed by a computer processor of trustee computer system 140 to provide the services discussed herein.

Member computer system 150 may be a computer system similar to computer system 200. Member computer system 150 may comprise member computer system datastore 151 similar to computer system datastore 300. Member computer system datastore 151 may comprise member module 700 as well as, for example, one or more private computer system member user account 125, and member private/public key 154. Member module 700 may be executed by a computer processor of member computer system 150 to provide the services discussed herein.

Network 160 may comprise computers, network connections among the computers, and software routines to enable communication between the computers over the network connections. Examples of Network 160 comprise an Ethernet network, the Internet, and/or a wireless network, such as a GSM, TDMA, CDMA, EDGE, HSPA, LTE or other network provided by a wireless service provider. Connection to Network 160 may be via a Wi-Fi connection. More than one network may be involved in a communication session between the illustrated devices. Connection to Network 160 may require that the computers execute software routines which enable, for example, the seven layers of the OSI model of computer networking or equivalent in a wireless phone network.

The disclosed computer systems may connect to one another and to datastores thereof through network 160.

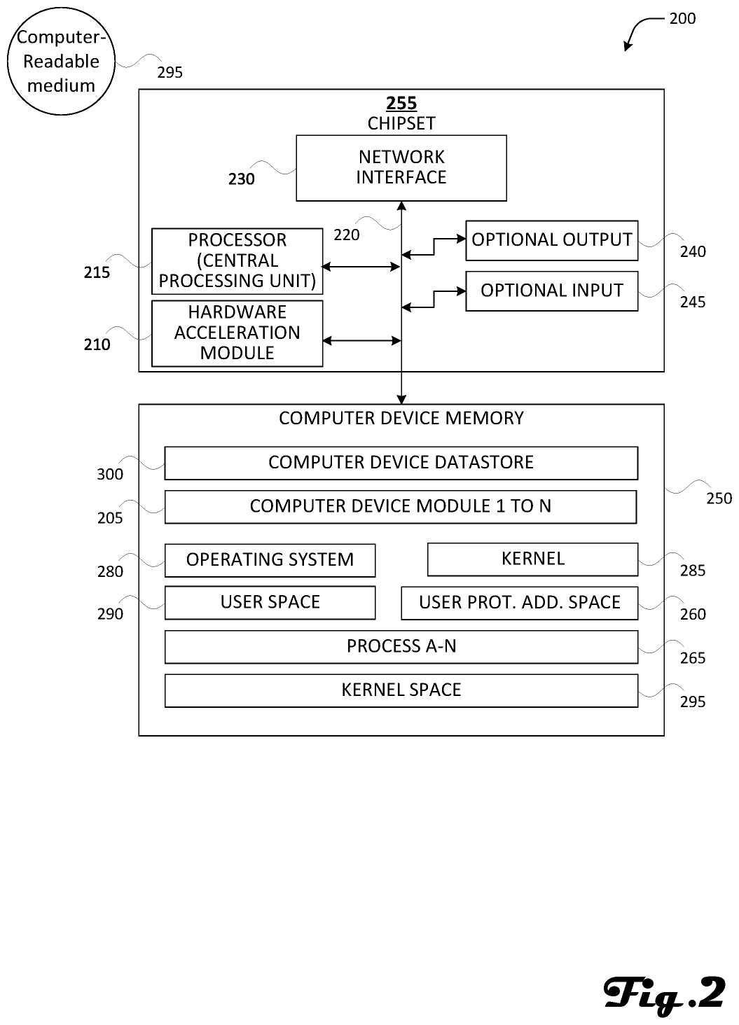

FIG. 2 is a functional block diagram illustrating an example of computer system 200, incorporated with teachings of the present disclosure, according to some embodiments. Computer system 200 is an example of a computer system which may provide one or more of XAND blockchain creation computer system 110, private computer system 120, trustee computer system 140, and or member computer system 150. Computer system 200 may be virtualized, such as in a virtual machine, including a virtual machine available from a cloud services provider. Computer system 200 may be virtualized across multiple virtual machines.

Computer system 200 may include chipset 255. Chipset 255 may include processor 215, input/output (I/O) port(s) and peripheral devices, such as output 240 and input 245, and network interface 230, and computer device memory 250, all interconnected via bus 220. Network interface 230 may be utilized to form connections with network 160, with computer system datastore 300, or to form device-to-device connections with other computers. Processor 215 may be similar to a processor of, for example, XAND blockchain creation computer system 110, trustee computer system, member computer system 150, and of XAND blockchain computer system 130.

Chipset 255 may include communication components and/or paths, e.g., buses 220, that couple processor 215 to peripheral devices, such as, for example, output 240 and input 245, which may be connected via I/O ports. Processor 215 may include one or more execution cores (CPUs). For example, chipset 255 may also include a peripheral controller hub (PCH) (not shown). In another example, chipset 255 may also include a sensors hub (not shown). Input 245 and output 240 may include, for example, user interface device(s) including a display, a touch-screen display, printer, keypad, keyboard, etc., sensor(s) including accelerometer, global positioning system (GPS), gyroscope, etc., communication logic, wired and/or wireless, storage device(s) including hard disk drives, solid-state drives, removable storage media, etc. I/O ports for input 245 and output 240 may be configured to transmit and/or receive commands and/or data according to one or more communications protocols. For example, one or more of the I/O ports may comply and/or be compatible with a universal serial bus (USB) protocol, peripheral component interconnect (PCI) protocol (e.g., PCI express (PCIe)), or the like.

Hardware acceleration module 210 may provide hardware acceleration of various functions otherwise performed by modules, program code, or processes in computer device memory 250. Hardware acceleration module may be provided by, for example, Integrated Performance Primitives software library by Intel Corporation, as may be executed by an Intel (or other compatible) chip, and which may implement, for example, a library of programming functions involved with real time computer vision and machine learning systems. Such a library includes, for example, OpenCV. OpenCV includes, for example, application areas including 2D and 3D feature toolkits, egomotion estimation, facial recognition, gesture recognition, human-computer interaction, mobile robotics, motion understanding, object identification, segmentation and recognition, stereopsis stereo vision (including depth perception from two cameras), structure from motion, motion tracking, and augmented reality. OpenCV also includes a statistical machine learning library including boosting, decision tree learning, gradient boosting trees, expectation-maximization algorithms, k-nearest neighbor algorithm, naïve Bayes classifier, artificial neural networks, random forest, and a support vector machine.

Hardware acceleration module may be provided by, for example, NVIDIA® CUDA-X libraries, tools, and technologies built on NVIDIA CUDA® technologies. Such libraries may comprise, for example, math libraries, parallel algorithms, image and video libraries, communication libraries, deep learning libraries, and partner libraries. Math libraries may comprise, for example, a GPU-accelerated basic linear algebra (BLAS) library, a GPU-accelerated library for Fast Fourier Transforms, a GPU-accelerated standard mathematical function library, a GPU-accelerated random number generation (RNG), GPU-accelerated dense and sparse direct solvers, GPU-accelerated BLAS for sparse matrices, a GPU-accelerated tensor linear algebra library, and a GPU-accelerated linear solvers for simulations and implicit unstructured methods. Parallel algorithm libraries may comprise, for example a GPU-accelerated library of C++ parallel algorithms and data structures. Image and video libraries may comprise, for example, a GPU-accelerated library for JPEG decoding, GPU-accelerated image, video, and signal processing functions, a set of APIs, samples, and documentation for hardware accelerated video encode and decode on various operating systems, and a software developer kit which exposes hardware capability of NVIDIA TURING™ GPUs dedicated to computing relative motion of pixels between images. Communication libraries may comprise a standard for GPU memory, with extensions for improved performance on GPUs, an open-source library for fast multi-GPU, multi-node communications that maximize bandwidth while maintaining low latency. Deep learning libraries may comprise, for example, a GPU-accelerated library of primitives for deep neural networks, a deep learning inference optimizer and runtime for product deployment, a real-time streaming analytics toolkit for AI-based video understanding and multi-sensor processing, and an open source library for decoding and augmenting images and videos to accelerate deep learning applications. Partner libraries may comprise, for example, OpenCV, FFmpeg, ArrayFire, Magma, IMSL Fortan Numerical Library, Gunrock, Cholmod, Triton Ocean SDK, CUVIlib, and others.

In embodiments, hardware acceleration module 210 may be or comprise a programmed FPGA, i.e., a FPGA which gate arrays are configured with a bit stream to embody the logic of the hardware accelerated function (equivalent to the logic provided by the executable instructions of a software embodiment of the function). In embodiments, hardware acceleration module 210 may also or alternatively include components of or supporting computer device memory 250.

Computer device memory 250 may generally comprise a random-access memory (“RAM”), a read only memory (“ROM”), and a permanent mass storage device, such as a disk drive or SDRAM (synchronous dynamic random-access memory). Computer device memory 250 may store program code for modules and/or software routines, represented by computer device module 1 to n 205. Examples of computer device module 1 to n 205 may comprise blockchain execution module 400, trustee module 1100, member module 700, and sub-modules thereof.

Computer device memory 250 may also store operating system 280 or the equivalent. These software components may be loaded from a non-transient computer readable storage medium 295 into computer device memory 250 using a drive mechanism associated with a non-transient computer readable storage medium 295, such as a floppy disc, tape, DVD/CD-ROM drive, memory card, or other like storage medium. In some embodiments, software components may also or instead be loaded via a mechanism other than a drive mechanism and computer readable storage medium 295 (e.g., via network interface 230).

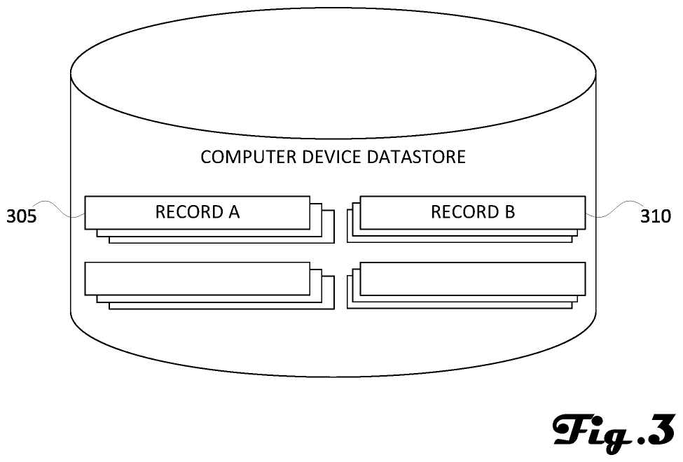

Computer device memory 250 is also illustrated as comprising kernel 285, kernel space 295, user space 290, user protected address space 260, and computer device datastore 300 (illustrated and discussed further in relation to FIG. 3).

Computer device memory 250 may store one or more process 265 (i.e., executing software application(s)). Process 265 may be stored in user space 290. Process 265 may include one or more other process 265a . . . 265n. One or more process 265 may execute generally in parallel, i.e., as a plurality of processes and/or a plurality of threads.

Computer device memory 250 is further illustrated as storing operating system 280 and/or kernel 285 (or equivalent). The operating system 280 and/or kernel 285 may be stored in kernel space 295. In some embodiments, operating system 280 may include kernel 285. Operating system 280 and/or kernel 285 may attempt to protect kernel space 295 and prevent access by certain of process 265a . . . 265n.

Kernel 285 may be configured to provide an interface between user processes and circuitry associated with computer system 200. In other words, kernel 285 may be configured to manage access to processor 215, chipset 255, I/O ports and peripheral devices by process 265. Kernel 285 may include one or more drivers configured to manage and/or communicate with elements of computer system 200 (i.e., processor 215, chipset 255, I/O ports and peripheral devices).

Computer system 200 may also comprise or communicate via bus 220 and/or network interface 230 with computer device datastore 300, illustrated and discussed further in relation to FIG. 3. In various embodiments, bus 220 may comprise a high-speed serial bus, and network interface 230 may be coupled to a storage area network (“SAN”), a high speed wired or wireless network, and/or via other suitable communication technology. Computer system 200 may, in some embodiments, include many more components than as illustrated. However, it is not necessary that all components be shown in order to disclose an illustrative embodiment.

FIG. 3 is a functional block diagram of the computer device datastore 300 illustrated in the computer device of FIG. 2, according to some embodiments. The components of computer device datastore 300 may include data groups used by modules and/or routines. Tow examples are illustrated, record A 305 and record B 310. Record A 305 and record B 310 may represent, for example, system software 136, blockchain-transferable record corresponding to private computer system user transferable object 138, blockchain execution module 400, private computer system blockchain node user account information 113, blockchain node private/public key 114, trustee user account 124, member user account 125, blockchain node user account 126, private computer system user transferable object 123, trustee module 1100, private computer system trustee user account(s) information 143, trustee private/public key 143, member module 700, private computer system member user account information 153, and or member private/public key 154. The data groups used by modules or routines illustrated in FIG. 3 may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, references to other database entries, joins, conditional logic, tests, and similar.

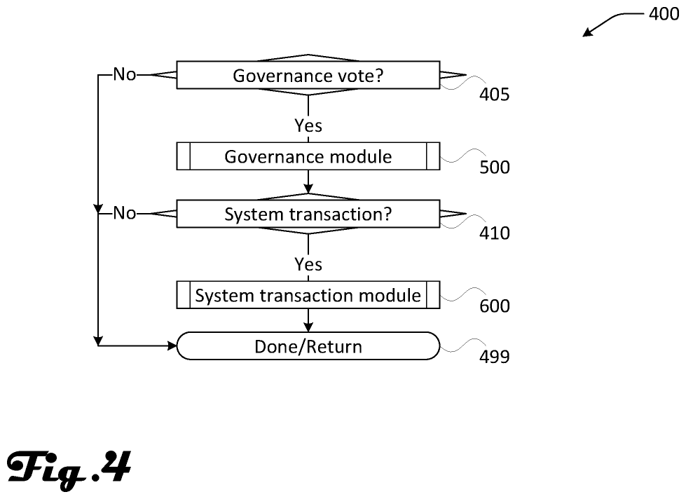

FIG. 4 is a flow diagram illustrating an example of a method performed by blockchain execution module 400, incorporated with teachings of the present disclosure, consistent with embodiments of the present disclosure. Blockchain execution module 400 may be stored in XAND blockchain creation computer system datastore 111 and may be executed by a processor of XAND blockchain creation computer system 110. A plurality of XAND blockchain creation computer systems 110A-N may execute blockchain execution module 400A-N in conjunction. Blockchain execution module 400 may participate in creation and governance of more than one XAND blockchain computer system 130. All XAND blockchain computer systems 130 do not have to interoperate, but may operate separately with respect to different private computer systems 120 and with different member modules 700 and trustee modules 1100.

At decision block 405, blockchain execution module 400 may determine whether a governance vote is requested or necessary, such as with respect to governance of XAND blockchain computer system 130. If affirmative or equivalent at decision block 405, blockchain execution module 400 may execute governance module 500 as a subroutine of the current module.

At decision block 410, blockchain execution module 400 may determine whether a system transaction is requested or necessary, such as with respect to operation of XAND blockchain computer system 130. If affirmative or equivalent at decision block 410, blockchain execution module 400 may execute system transaction module 600 as a subroutine of the current module.

If negative or equivalent at decision block 405 or decision block 410, blockchain execution module 400 may proceed to done or return block 499.

At done or return block 499, blockchain execution module 400 may return to decision block 405, to another process which may have called it, or may conclude. Blockchain execution module 400 may thereby create and maintain XAND computer system 130 as a distributed, permissioned, proof-of-authority blockchain computer system.

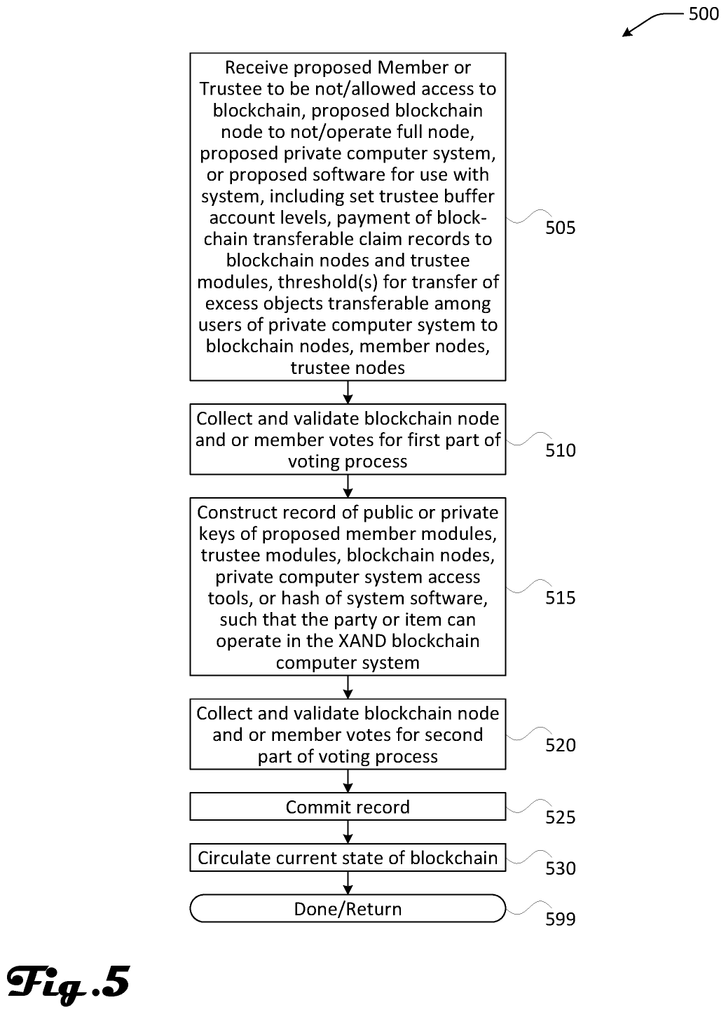

FIG. 5 is a flow diagram illustrating an example of a method performed by governance module 500, incorporated with teachings of the present disclosure, consistent with embodiments of the present disclosure. Governance module 500 may be stored in XAND blockchain creation computer system datastore 111 and may be executed by a processor of XAND blockchain creation computer system 110.

At block 505, governance module 500 may receive one or more proposed members or trustees to be allowed or not allowed access to XAND blockchain computer system 130, such as via member module 700 or trustee module 1100. At block 505, governance module 500 may further or alternatively receive one or more proposed blockchain nodes to be allowed or not allowed to operate a full blockchain node 105 of XAND blockchain computer system 130, such as via blockchain execution module 400. The proposal may include information regarding the proposed party, technical information, compensation requested by the proposed party, private computer systems used by the proposed party, other parties with whom the proposed party may interact through the XAND blockchain computer system 130, and the like.

At block 505, governance module 500 may further or alternatively receive one or more proposed private computer system for use with XAND blockchain computer system 130. The proposed private computer system may be, for example, a multi-player computer game system, a software provisioning computer system, a bank, a loyalty rewards computer system, or the like. The proposal may comprise information regarding the private computer system, such as an application program interface of the private computer system, a private computer system user transferable object, a number of private computer systems which transfer the private computer system user transferable object, requirements to hold an account at the private computer system, a number of users of the private computer system, and the like.

At block 505, governance module 500 may further or alternatively receive one or more proposed software or software modifications or software settings for use with XAND blockchain computer system 130, such as for system software 136.

For example, proposed system software may comprise one or more of blockchain execution module 400, trustee module 1100, member module 700, and or consensus algorithm used by one or more of the foregoing modules. In addition to other functions discussed herein, trustee module 1100 or records used thereby, may set or modify a level of buffer accounts at private computer system 120 which trustee module 1100 is to maintain, wherein trustee module 1100 may use said buffer accounts to address latency in transfer of private computer system user transferable objects between users among a plurality of private computer systems. In addition to other functions discussed herein, trustee module 1100 or records used thereby, may set or modify an amount of compensation paid to one or more of blockchain execution module 400, member module 700, and trustee module 1100, wherein the compensation may be paid in creation of one or more blockchain-transferable record redeemable for a private computer system user transferable object. In addition to other functions discussed herein, trustee module 1100 or records used thereby may set or modify a threshold at which trustee module 1100 may transfer to one or more of blockchain execution module 400, member module 700, or trustee module 1100 any excess which may have accumulated in accounts of trustee module 1100 at private computer system 120, for example, due to interest earned or deflation in loyalty point value.

At block 510, governance module 500 may collect and validate blockchain node or member votes with respect to the proposals of block 505. Voting rules may be specific to different types of proposals, with different quorum thresholds and different thresholds to adopt the proposal. For example, passage of certain proposals may require participation of all member modules of an XAND blockchain computer system 130. For example, adding or removing a member and corresponding member module 700, setting a target level of a private computer system trustee user account 124, adding or removing a private computer system 120 for use with XAND blockchain computer system 130, may require a vote by all member modules 700 (or another number or percental of member modules 700) of XAND blockchain computer system 130 and may require a vote by a different number or percentage of blockchain execution modules 400, such a majority of blockchain execution modules 400.

Voting rules may follow a two-part process in which a first part comprises a member vote of member modules 700, in which all member modules 700 must participate, and in which passage of a proposal occurs with a majority of votes in favor. The first part may be followed by a second part comprising a network vote of member modules 700 and blockchain execution modules 400 to permission the party or item for use with the XAND blockchain computer system 130. The second part of the voting process may require, for example, a participation (or quorum) of fifty-one percent of blockchain execution modules 400 and of forty-nine percent of member modules, and in which passage occurs with two-thirds of votes in favor.

Following an affirmative vote with respect to a proposal in block 510, which affirmative vote may be a first part of a voting process, in block 515, governance module 500 may, for example, construct a record of keys of proposed member modules, trustee modules, blockchain nodes, private computer system access tools or identifiers, a hash of proposed system software, or the like, which record may be required for the proposed party or item to operate in the XAND blockchain computer system 130.

At block 520, governance module 500 may collect and validate blockchain execution module 400 and member module 700 votes in a second part of the voting process and may determine whether the vote met the voting criteria or not.

Following determination of an affirmative vote at block 520, at block 525 governance module 500 may commit the constructed record of block 515 as one or more record in the XAND blockchain computer system datastore 131.

At block 530, governance module 500 may circulate the then-current state of the XAND blockchain computer system 130.

At done or return block 599 governance module 500 may return to a process which may have called it or may conclude.

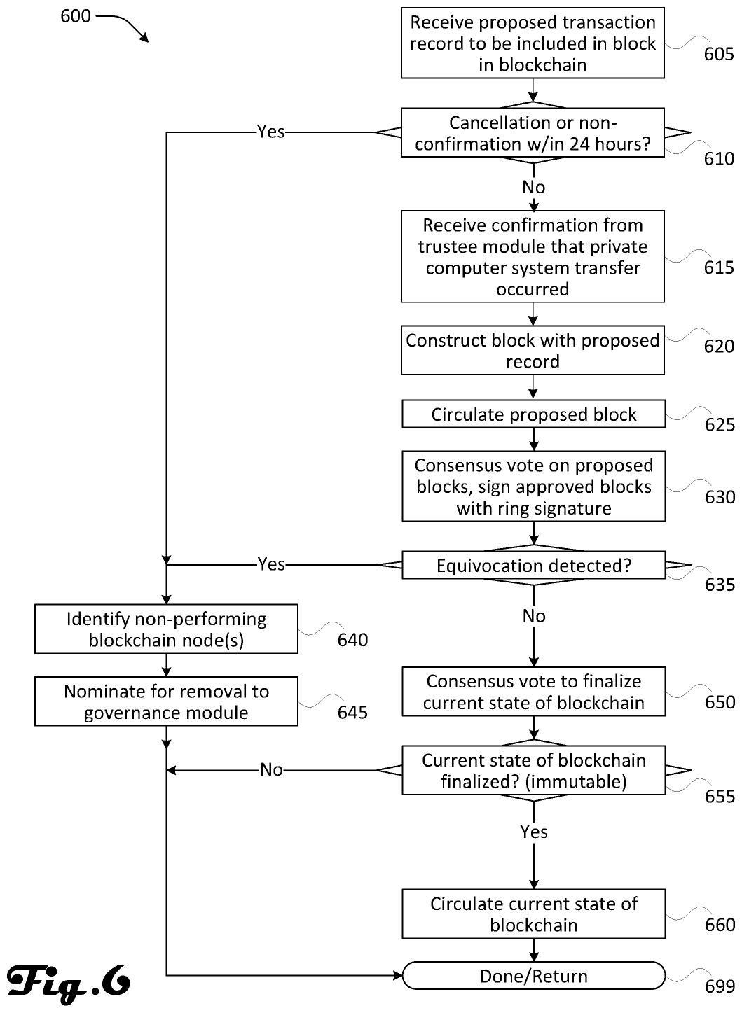

FIG. 6 is a flow diagram illustrating an example of a method performed by system transaction module 600, incorporated with teachings of the present disclosure, consistent with embodiments of the present disclosure. System transaction module 600 may be stored in XAND blockchain creation computer system datastore 111 and may be executed by a processor of XAND blockchain creation computer system 110.

At block 605, system transaction module 600 may receive a proposed transaction record proposed to be included in a block in XAND blockchain computer system datastore 131. For example, the proposed transaction record may be from a first member module 700A to create a blockchain-transferable record corresponding to private computer system user transferable object 138, to transfer such a record to a second member module 700B, or to redeem a blockchain-transferable record corresponding to private computer system user transferable object 138 in exchange for private computer system user transferable object 123. Which blockchain execution module 400 receives the proposed transaction record may be determined, for example, on a round-robin or other basis.

At decision block 610, if relevant, system transaction module 600 may determine whether a cancellation of the proposed transaction record of block 605 has been received, such as from trustee module 1100, or whether a transfer of private computer system user transferable object 123 of the proposed transaction record of block 605 has not been confirmed by trustee module 1100 within, for example, twenty-four hours of receipt of the proposed transaction record of block 605. This may not be required if, for example, the proposed transaction record of block 605 is merely to transfer such a record to a second member module 700B or is to redeem a blockchain-transferable record corresponding to private computer system user transferable object 138 in exchange for private computer system user transferable object 123.

At block 615, system transaction module 600 may receive a confirmation from trustee module 1100 that transfer of private computer system user transferable object 123 of the proposed transaction record of block 605 occurred.

At block 620, system transaction module 600 may construct a proposed block with the proposed record. If the proposed record or block is of a type creation of which entitles a blockchain execution module 400 to compensation, such a blockchain-transferable record corresponding to private computer system user transferable object 138, the proposed record or block may include the proposed compensation.

At block 625, system transaction module 600 may circulate the proposed block to other blockchain execution modules 400.

At block 630, system transaction module 600 may participate in a consensus algorithm vote on proposed blocks with other blockchain execution modules 400, signing blocks it approves of with a ring signature, wherein the ring signature allows confirmation that parties within a group signed.

At decision block 635, system transaction module 600 may determine whether equivocation occurred among blockchain execution modules 400 participating in the consensus vote on proposed blocks of block 630. Equivocation may be identified, for example, by finalized blocks on the same level, e.g. an incipient fork in Merkle tree 137. Equivocation may be caused by faulty software or a blockchain execution module 400 which is operating in bad faith or maliciously.

If affirmative or equivalent at decision block 635, at block 640 system transaction module 600 may identify a non-performing blockchain node 105 or blockchain execution module 400.

At block 645, system transaction module 600 may nominate the non-performing blockchain node 105 for removal to governance module 500 and may then proceed to done or return block 699. Along this path, the proposed transaction record of block 605 will not be finalized and made immutable unless the consensus algorithm can be met, e.g. if two-thirds of blockchain execution modules 400 vote in favor, without participation of the current blockchain execution module 400. This may not be possible if, for example, the consensus algorithm requires more than two-thirds of the blockchain execution modules 400 of the XAND blockchain computer system 130 and if one-third of the blockchain execution modules 400 of the XAND blockchain computer system 130 recognize or agree with the finding of equivocation and follow the path of block 645.

If negative or equivalent at decision block 635, at block 650, system transaction module 600 may participate in a consensus vote to finalize the current state of the blockchain and Merkle tree 137, including the proposed block of block 625.

At decision block 655, system transaction module 600 may determine whether the consensus vote of block 650 finalized the current state of the blockchain and Merkle tree 137 including the proposed block of block 630, making it immutable.

If affirmative or equivalent at decision block 655, at block 660 system transaction module 600 may circulate the then-current state of XAND blockchain computer system datastore 131, including the proposed block of block 630.

If negative or equivalent at decision block 655, system transaction module 600 may proceed to done or return block 699 without finalizing the current state of the XAND blockchain computer system datastore 131, and the proposed block of block 630 will not be included in the current state of the XAND blockchain computer system datastore 131.

At done or return block 699, system transaction module 600 may return to another process which may have called it or may conclude.

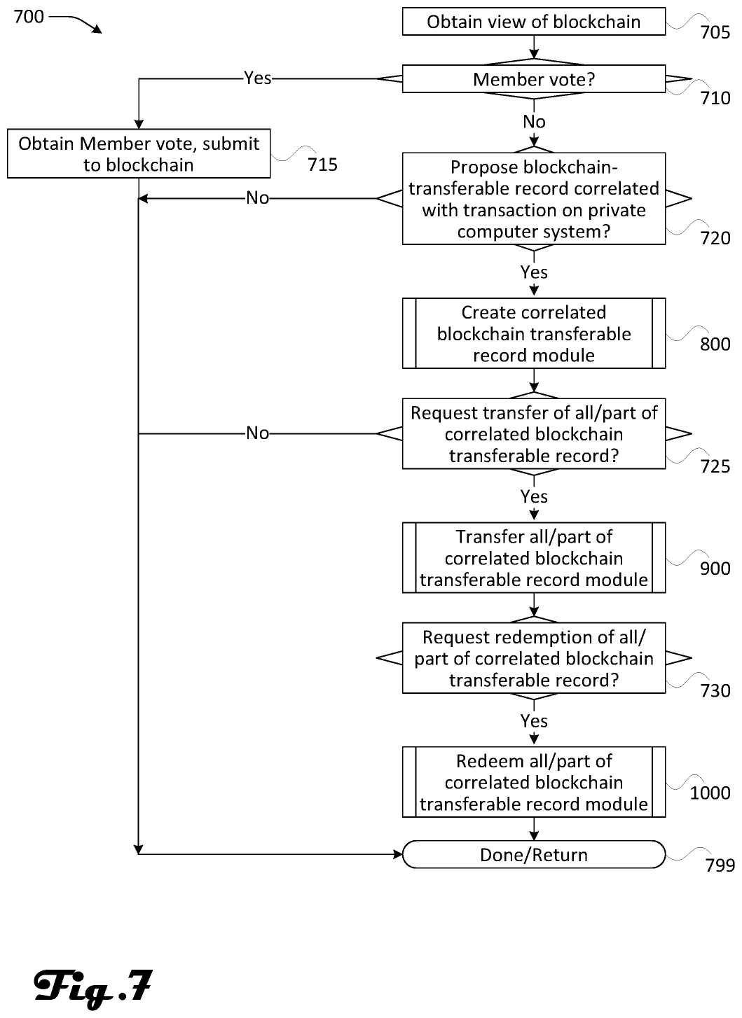

FIG. 7 is a flow diagram illustrating an example of a method performed by member blockchain module 700, incorporated with teachings of the present disclosure, consistent with embodiments of the present disclosure. Member blockchain module 700 may be stored in member computer system datastore 151 and may be executed by a processor of member computer system 150.

At block 705, member blockchain module 700 may obtain a view of XAND blockchain computer system 130 and XAND blockchain computer system datastore 131.

At decision block 710, member blockchain module 700 may determine whether a member vote is required, such as by governance module 500.

If affirmative or equivalent at decision block 710, member blockchain module 700 may obtain a vote from an operator of member blockchain module 700, such as an operator of member computer system 150, and submit the vote to the blockchain, such as to governance module 500.

If negative or equivalent at decision block 710, at decision block 720, member blockchain module 700 may determine whether an operator of member blockchain module 700 would like to propose a blockchain-transferable record corresponding to a private computer system user transferable object 138.

If affirmative or equivalent at decision block 720, at block 800, member blockchain module 700 may call or execute create correlated blockchain-transferable record module 800 as a submodule of the current module.

At decision block 725, member blockchain module 700 may determine whether an operator of member blockchain module 700 would like to request a transfer of all or part of a blockchain-transferable record corresponding to a private computer system user transferable object 138.

If affirmative or equivalent at decision block 725, at block 900, member blockchain module 700 may call or execute transfer all or part of correlated blockchain-transferable record module 900 as a submodule of the current module.

At decision block 730, member blockchain module 700 may determine whether an operator of member blockchain module 700 would like to request redemption of all or part of a blockchain-transferable record corresponding to a private computer system user transferable object 138.

If affirmative or equivalent at decision block 730, at block 1000, member blockchain module 700 may call or execute redeem all or part of correlated blockchain-transferable record module 1000 as a submodule of the current module.

At done or return block 799, member blockchain module 700 may return to another process which may have called it or may conclude.

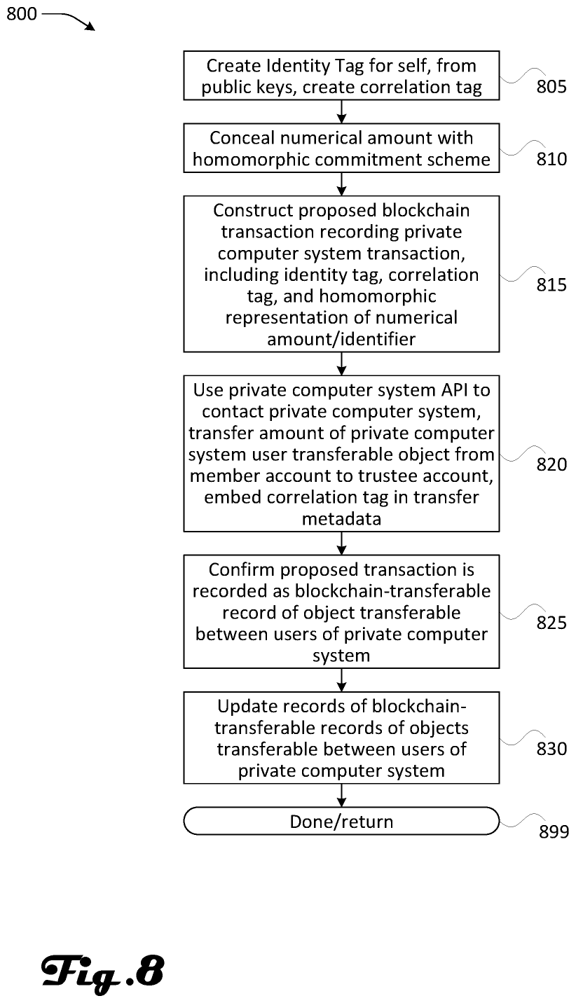

FIG. 8 is a flow diagram illustrating an example of a method performed by create correlated blockchain transferable record module 800, incorporated with teachings of the present disclosure, consistent with embodiments of the present disclosure. Create correlated blockchain transferable record module 800 may be stored in member computer system datastore 151 and may be executed by a processor of member computer system 150. Create correlated blockchain transferable record module 800 may be called to propose creation of a blockchain-transferable record corresponding to a private computer system user transferable object.

At block 805, create correlated blockchain transferable record module 800 may create an identify tag for itself, such as from member private or public key 154. At block 805, create correlated blockchain transferable record module 800 may create or obtain a correlation tag. The correlation tag may be randomly generated or may be hash of other pertinent records.

At block 810, create correlated blockchain transferable record module 800 may conceal a numerical amount of an amount of a private computer system user transferable object 123 to be transferred, such as using a homomorphic commitment scheme. The homomorphic commitment scheme may conceal the amount, though may allow the amount to be subtracted or added to another amount, such as another amount also concealed by the homomorphic commitment scheme.

At block 815, create correlated blockchain transferable record module 800 may construct a proposed transaction to record a blockchain-transferable record corresponding to the private computer system user transferable object to be transferred. The proposed transaction record may comprise the identity tag and correlation tag of block 805 and the homomorphic representation of the amount of block 810.

At block 820, create correlated blockchain transferable record module 800 may use an application program interface of a private computer system 120 and credentials of member module 700 to transfer an amount of a private computer system user transferable object 123 from member user account 125 to trustee user account 124. The amount may be sufficient to create blockchain-transferable record corresponding to private computer system user transferable object 138 for member module 700 as well as to create a blockchain-transferable record corresponding to private computer system user transferable object 138 to compensate blockchain execution module 400. Create correlated blockchain transferable record module 800 may embed the correlation tag of block 805 in metadata in the transfer.

At block 825, create correlated blockchain transferable record module 800 may confirm that the proposed transaction is recorded as a blockchain-transferable record of object transferable between users of private computer system 138 at an address in control of member module 700.

At block 830, create correlated blockchain transferable record module 800 may update records of blockchain-transferable record of object transferable between users of private computer system 138 available to member module 700.

At done or return block 899, create correlated blockchain transferable record module 800 may return to a process which may have called it and or may conclude.

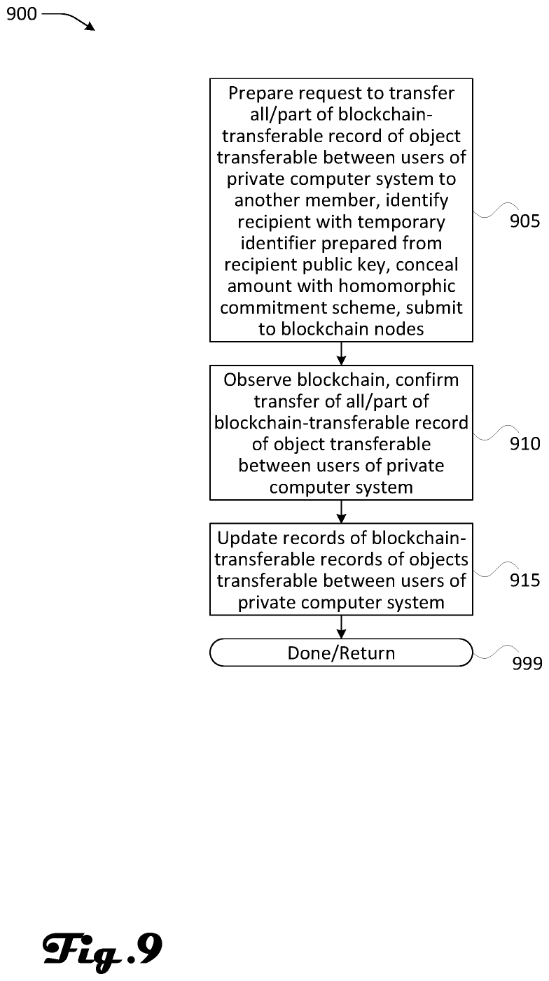

FIG. 9 is a flow diagram illustrating an example of a method performed by transfer all or part of a correlated blockchain transferable record module 900, incorporated with teachings of the present disclosure, consistent with embodiments of the present disclosure. Transfer all or part of a correlated blockchain transferable record module 900 may be stored in member computer system datastore 151 and may be executed by a processor of member computer system 150. Transfer all or part of a correlated blockchain transferable record module 900 may be called to transfer all or part of a blockchain-transferable record corresponding to a private computer system user transferable object to another member of XAND blockchain computer system 130, such as to an address under control of the recipient's member module 700.

At block 905, transfer all or part of a correlated blockchain transferable record module 900 may prepare a request to transfer all or part of blockchain-transferable record corresponding to a private computer system user transferable object 138 under control of the current member module 700A to another member, such as to another member module 700B. The other member module 700B or recipient may be identified with, for example, a temporary identifier prepared from a public key of the recipient member module 700B. An amount of the transfer may be concealed with, for example, a homomorphic commitment scheme.

At block 910, transfer all or part of a correlated blockchain transferable record module 900 may observe XAND blockchain computer system datastore 131 and confirm transfer of all or part of blockchain-transferable record corresponding to a private computer system user transferable object 138 to the address in XAND blockchain computer system datastore 131 under the control of the other member.

At block 915, transfer all or part of a correlated blockchain transferable record module 900 may update records of blockchain-transferable records of objects transferable between users of private computer system.

At done or return block 999, transfer all or part of a correlated blockchain transferable record module 900 may return to a process which may have called it or may conclude.

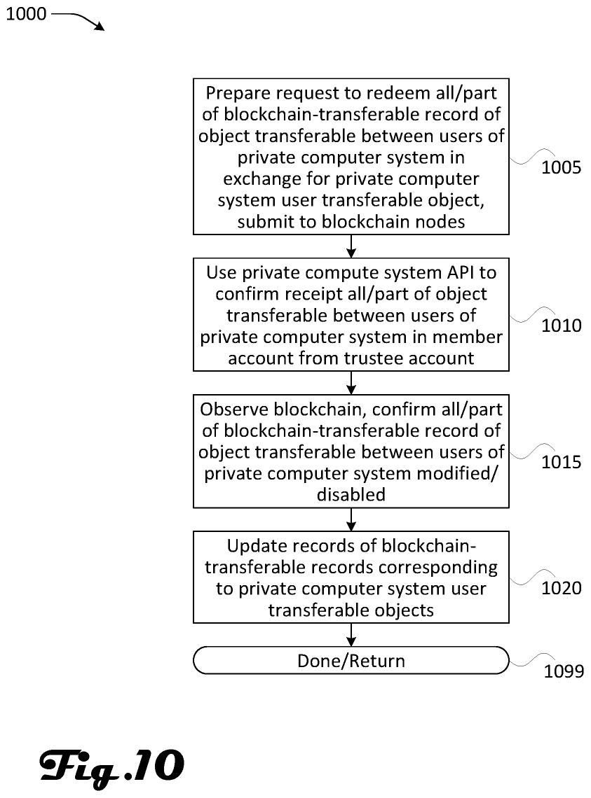

FIG. 10 is a flow diagram illustrating an example of a method performed by redeem all or part of a correlated blockchain transferable record module 1000, incorporated with teachings of the present disclosure, consistent with embodiments of the present disclosure. Redeem all or part of a correlated blockchain transferable record module 1000 may be stored in member computer system datastore 151 and may be executed by a processor of member computer system 150.

At block 1005, redeem all or part of a correlated blockchain transferable record module 1000 may prepare and submit to blockchain nodes 105 a request to redeem all or part blockchain-transferable record corresponding to private computer system user transferable object 138 in exchange for private computer system user transferable object 123. Redemption of all or part blockchain-transferable record corresponding to private computer system user transferable object 138 may result in modification or disablement of a corresponding blockchain-transferable record corresponding to private computer system user transferable object 138 at an address under control of member module 700 and in receipt of a corresponding amount of private computer system user transferable object 138 in member user account 125 of member module 700.

At block 1010, redeem all or part of a correlated blockchain transferable record module 1000 may use private computer system application program interface and private computer system credentials of member module 700 to confirm receipt of all or part of private computer system user transferable object 123 in member user account 125, such as from trustee user account 124.

At block 1015, redeem all or part of a correlated blockchain transferable record module 1000 may observe XAND blockchain computer system datastore 131 and confirm modification or disablement of a corresponding blockchain-transferable record corresponding to private computer system user transferable object 138 at the address under control of member module 700.

At block 1020, redeem all or part of a correlated blockchain transferable record module 1000 may update records of blockchain-transferable records corresponding to private computer system user transferable objects 138.

At done or return block 1099, redeem all or part of a correlated blockchain transferable record module 1000 may return to a process which may have called it or may conclude.

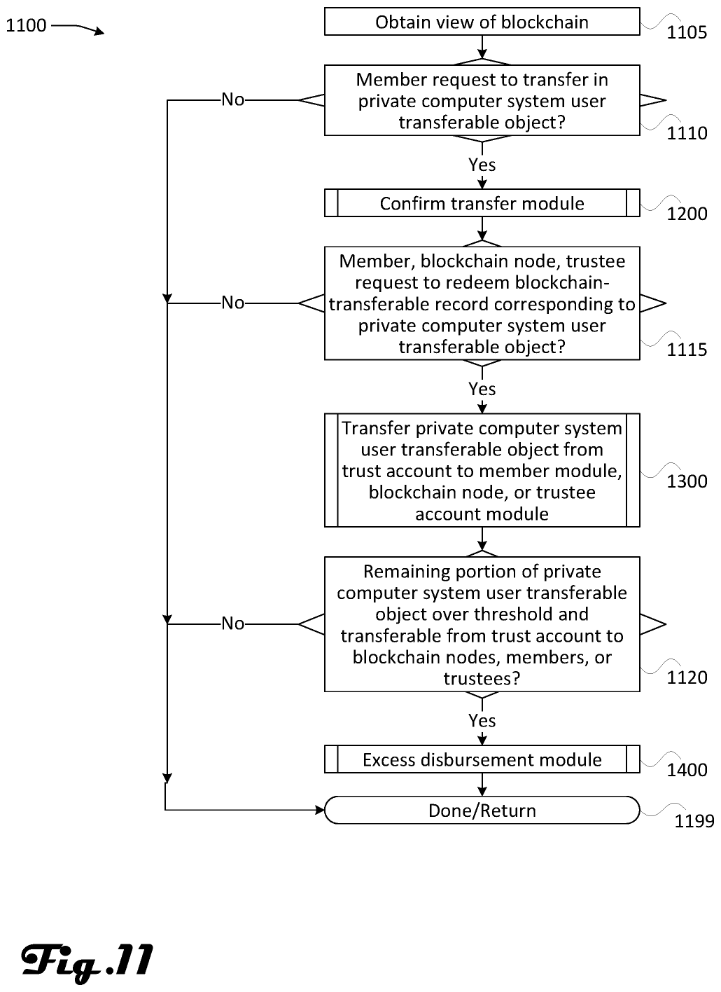

FIG. 11 is a flow diagram illustrating an example of a method performed by trustee blockchain module 1100, incorporated with teachings of the present disclosure, consistent with embodiments of the present disclosure. Trustee blockchain module 1100 may be stored in trustee computer system datastore 141 and may be executed by a processor of trustee computer system 141.

At block 1105, trustee blockchain module 1100 may obtain a view of XAND blockchain computer system datastore 131.

At decision block 1110, trustee blockchain module 1100 may determine if a member, such as through a member module 700, has requested to transfer private computer system user transferable object 123 to trustee user account 124 of trustee module 1100 in private computer system 120 in exchange for creation of blockchain-transferable record corresponding to private computer system user transferable object.

If affirmative or equivalent at decision block 1110, at block 1200, trustee blockchain module 1100 may call or execute confirm transfer module 1200 as a submodule.

At decision block 1115, trustee blockchain module 1100 may determine if a member, such as through a member module 700, blockchain node 105, or trustee module 1100 has requested to redeem a blockchain-transferable record corresponding to private computer system user transferable object 138.

If affirmative or equivalent at decision block 1115, at block 1300, trustee blockchain module 1100 may call or execute transfer private computer system user transferable object from trust account to member module, blockchain node, or trustee account module 1300 as a submodule.

At decision block 1120, trustee blockchain module 1100 may determine if a remaining portion of private computer system user transferable object is over a threshold and is to be transferred from private computer system trustee user account 124 to private computer system member user account 125, blockchain node user account 126, or trustee account 124.

If affirmative or equivalent at decision block 1120, at block 1400, trustee blockchain module 1100 may call or execute excess disbursement module 1400 as a submodule.

At done or return block 1199, trustee blockchain module 1100 may return to another process which may have called it or may conclude.

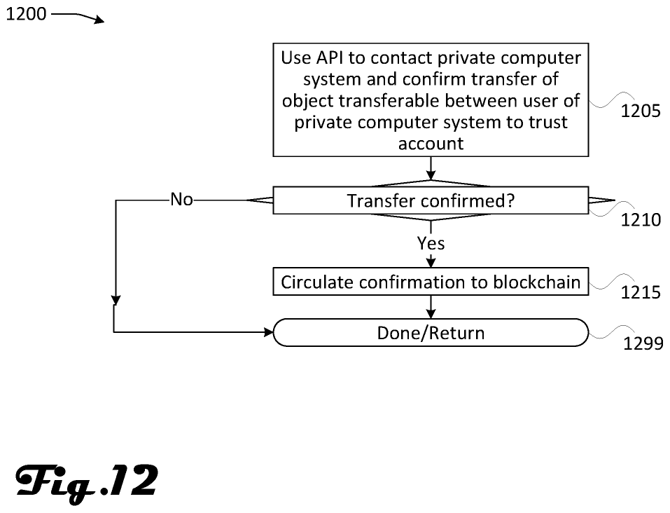

FIG. 12 is a flow diagram illustrating an example of a method performed by confirm transfer module 1200, incorporated with teachings of the present disclosure, consistent with embodiments of the present disclosure. Confirm transfer module 1200 may be stored in trustee computer system datastore 141 and may be executed by a processor of trustee computer system 141. Confirm transfer module 1200 may be executed following identification of a member request to transfer private computer system user transferable object 123 to trustee user account 124 of trustee module 1100 in private computer system 120 in exchange for creation of blockchain-transferable record corresponding to private computer system user transferable object.

At block 1205, confirm transfer module 1200 may use an application program interface of private computer system 120 to contact private computer system 120 and confirm transfer to trustee user account 124 private computer system user transferable object 123.

At decision block 1210, confirm transfer module 1200 may determine if the transfer is confirmed by private computer system 120.

If affirmative or equivalent at decision block 1210, at block 1215 confirm transfer module 1200 may circulate a confirmation to the blockchain and blockchain nodes 105.

At done or return block 1299, confirm transfer module 1200 may return to a process which may have called it or may conclude.

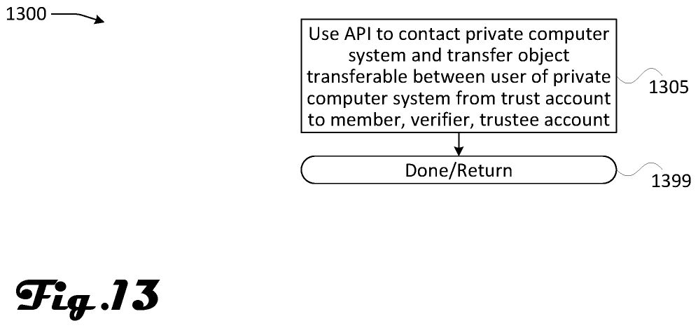

FIG. 13 is a flow diagram illustrating an example of a method performed by transfer object transferable between user of private computer system from trust account to member, blockchain node, or trustee account module 1300, incorporated with teachings of the present disclosure, consistent with embodiments of the present disclosure. Transfer object transferable between user of private computer system from trust account to member, blockchain node, or trustee account module 1300 may be stored in trustee computer system datastore 141 and may be executed by a processor of trustee computer system 141. Transfer object transferable between user of private computer system from trust account to member, blockchain node, or trustee account module 1300 may be executed to transfer an object transferable between users of private computer system 120 from trustee user account 124 to member module 700, blockchain node 105, or trustee account module 1100, such as in response to a request by redeem all or part of correlated blockchain-transferable record module 1000.

At block 1305, transfer object transferable between user of private computer system from trust account to member, blockchain node, or trustee account module 1300 may use an application program interface of private computer system 120 to contract private computer system 120 and transfer private computer system user transferable object 123 from trustee user account 124 to an account of the requesting party, such as to a member user account 125, blockchain node user account 126, or trustee user account 124 at private computer system 120.

At done or return block 1399, transfer object transferable between user of private computer system from trust account to member, blockchain node, or trustee account module 1300 may return to a process which may have called it or may conclude.

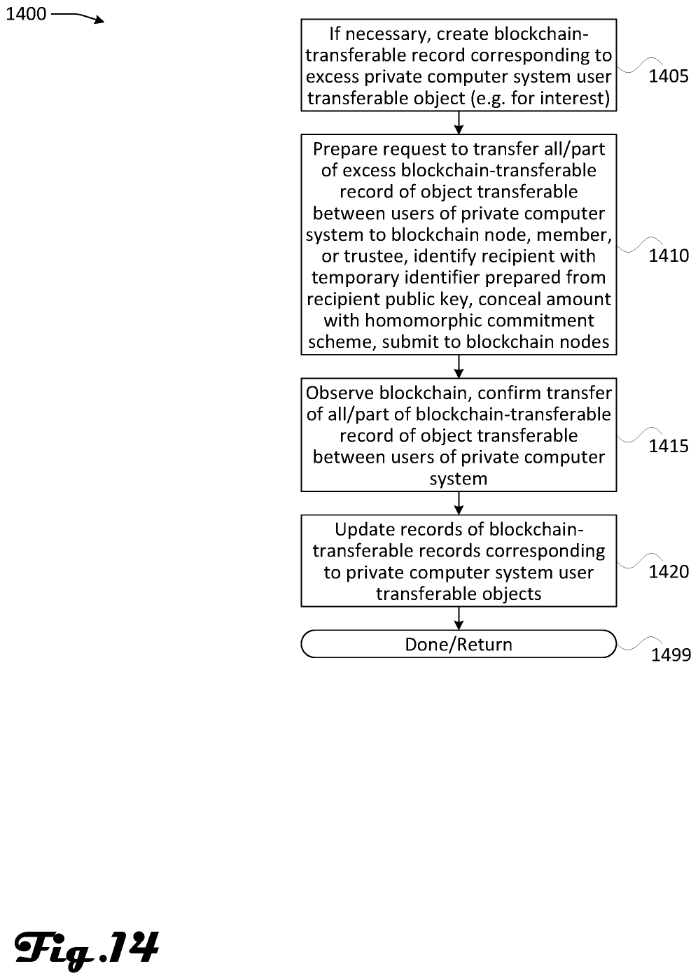

FIG. 14 is a flow diagram illustrating an example of a method performed by excess disbursement module 1400, incorporated with teachings of the present disclosure, consistent with embodiments of the present disclosure. Excess disbursement module 1400 may be stored in trustee computer system datastore 141 and may be executed by a processor of trustee computer system 141. Excess disbursement module 1400 may be executed when a remaining or excess portion of private computer system user transferable object in trustee user account 124 at private computer system 120 is over a threshold and transferable from trust account to blockchain nodes, members, or trustees. This may occur, for example, when private computer system user transferable object 123 earns interest or is subject to deflation.

Generally, in XAND blockchain computer system 130 there will be a one-to-one correspondence between blockchain-transferable records and private computer system user transferable objects transferred to trustee user account 124. However, if private computer system user transferable object 123 earned interest or was subject to deflation which increased it value, there may be no corresponding blockchain-transferable record corresponding to such interest or increase in value. In which case, at block 1405, excess disbursement module 1400 may, if necessary, create a blockchain-transferable record corresponding to excess private computer system user transferable object 123. This may be created by, for example, calling create correlated blockchain-transferable record module 800, without performance of block 820.

At block 1410, excess disbursement module 1400 may prepare a request to transfer all or part of the blockchain-transferable record corresponding to excess private computer system user transferable object 123 to a member, a blockchain node, or a trustee. The request may identify the recipient with a temporary identifier prepared from the recipient public key, may conceal the amount with the homomorphic commitment scheme. Excess disbursement module 1400 may submit the request to blockchain nodes 105 and blockchain execution modules 400. The request may be performed by calling transfer all or part of correlated blockchain-transferable record module 900.

At block 1415, excess disbursement module 1400 may observe the XAND blockchain computer system datastore 131 to confirm transfer of all or part of the excess blockchain-transferable record of object transferable between users of private computer system.

At block 1420, excess disbursement module 1400 may update records of blockchain-transferable records corresponding to private computer system user transferable objects.

At done or return block 1499, excess disbursement module 1400 may return to a process which may have called it or may conclude.

When a party or module thereof receives disbursement of a blockchain-transferable record corresponding to private computer system user transferable object 138 from excess disbursement module 1400, the recipient may act as a member and may execute member module 700 to transfer or redeem the blockchain-transferable record corresponding to private computer system user transferable object 138.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions. USB (Universal serial bus) may comply or be compatible with Universal Serial Bus Specification, Revision 2.0, published by the Universal Serial Bus organization, Apr. 27, 2000, and/or later versions of this specification, for example, Universal Serial Bus Specification, Revision 3.1, published Jul. 26, 2013. PCIe may comply or be compatible with PCI Express 3.0 Base specification, Revision 3.0, published by Peripheral Component Interconnect Special Interest Group (PCI-SIG), November 2010, and/or later and/or related versions of this specification.

As used herein, a “blockchain computer system” is a decentralized, distributed, public computer system in which blockchain nodes cryptographically hash successive blocks of data to a blockchain datastore according to a time-stamping technique; time-stamping techniques include, for example, proof-of-stake and proof-of-work. Blockchain computer systems are governed by blockchain rules, which may be understood as operating systems for blockchain computer systems. Blockchain rules generally require consensus of greater than a threshold of then-current blockchain nodes (typically a more than half) to add new blocks to the blockchain; correspondingly, blockchain rules generally prevent changes to the entire set of records in a blockchain, including past records, without consensus. Blockchain rules are generally permissionless for public blockchains, which means that records and/or application scan be added to the blockchain datastore applications without access control and without the approval or trust of others, using the blockchain rules as a transport layer. Processing and storage of records in the blockchain datastore according to the blockchain rules is performed by one or more blockchain nodes. Blockchain rules for certain blockchain computer systems, such as the Ethereum network, allow executable code or “smart contracts” to be stored in the blockchain datastore. Examples of blockchain computer systems include the Bitcoin network, the Ethereum network, and the like.

As used herein, a “blockchain datastore” is a series of blocks of data, wherein each subsequent block in the series includes a cryptographic hash of one or more preceding blocks in the series. A blockchain datastore is the current state of a blockchain computer system. The blocks of data generally comprise a hash of a previous block of data, a timestamp, and a transaction data. A blockchain datastore may be represented as a Merkle tree.

As used herein, a “blockchain node” is a computer which follows blockchain rules of a blockchain computer system. Blockchain nodes i) write or have written one or more blocks of data to a blockchain datastore and/or ii) access and report the contents of a blockchain datastore. Blockchain nodes may execute a blockchain virtual machine to access and process records in the blockchain datastore.

As used herein, a “smart contract” is a software routine, process, or logic for a module in a blockchain computer system. Smart contracts are written to a datastore of a blockchain computer system and are executed by blockchain nodes.

As used in any embodiment herein, the term “logic” may refer to the logic of the instructions of an app, software, and/or firmware, and/or the logic embodied into a programmable circuitry by a configuration bit stream, to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as FPGA. The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

As used herein, the term “module” (or “logic”) may refer to, be part of, or include an Application Specific Integrated Circuit (ASIC), a System on a Chip (SoC), an electronic circuit, a programmed programmable circuit (such as, Field Programmable Gate Array (FPGA)), a processor (shared, dedicated, or group) and/or memory (shared, dedicated, or group) or in another computer hardware component or device that execute one or more software or firmware programs having executable machine instructions (generated from an assembler and/or a compiler) or a combination, a combinational logic circuit, and/or other suitable components with logic that provide the described functionality. Modules may be distinct and independent components integrated by sharing or passing data, or the modules may be subcomponents of a single module or be split among several modules. The components may be processes running on, or implemented on, a single compute node or distributed among a plurality of compute nodes running in parallel, concurrently, sequentially or a combination, as described more fully in conjunction with the flow diagrams in the figures.

As used herein, a process corresponds to an instance of a program, e.g., an application program, executing on a processor and a thread corresponds to a portion of the process. A processor may include one or more execution core(s). The processor may be configured as one or more socket(s) that may each include one or more execution core(s).

Following are non-limiting examples:

Example 1. A system to correlate transfer of private computer system user transferable objects with blockchain-transferable records, comprising: a first plurality of computer processors and a first plurality of computer memories of a first plurality of blockchain creation and maintenance computer systems, wherein each of the first plurality of computer memories comprise a blockchain execution module, wherein the first plurality of computer processors are each to separately execute the blockchain execution module and are to thereby: create a blockchain computer system, wherein immutable changes to the blockchain computer system are only allowed by the blockchain execution module according to a consensus algorithm of the blockchain computer system, wherein execution instances of the blockchain execution module and execution instances of a member module participate in the consensus algorithm by voting; provide a first member module in a first member computer memory and executed by a first member computer processor with permissioned access to the blockchain computer system; circulate and validate a first request from the first member module to record in the blockchain computer system a first transfer of a first private computer system user transferable object from a first account in the private computer system under control of the first member module to a second account in the private computer system under control of a trustee module as a proposed first blockchain-transferable record of the first private computer system user transferable object, wherein the trustee module is to hold in trust the first private computer system user transferable object for any instance of a blockchain execution module, member module, or trustee module with control over at least a portion of a blockchain-transferable record of the first private computer system user transferable object; circulate and validate a confirmation from the trustee module that the first transfer of the first private computer system user transferable object from the first account in the private computer system under control of the first member module to the second account in the private computer system under control of the trustee module occurred; in response to validation of the confirmation that the first transfer of the first private computer system user transferable object occurred, commit in the blockchain computer system the proposed first blockchain-transferable record of the first private computer system user transferable object as a first blockchain-transferable record of the first private computer system user transferable object, recorded at a first address on the blockchain computer system such that the blockchain computer system limits control over the first blockchain-transferable record of the first private computer system user transferable object to only the first member module; circulate and validate a second request from the first member module for a second transfer of a first portion of the first blockchain-transferable record of the first private computer system user transferable object to a second address on the blockchain computer system associated with a second member module associated with a second member computer processor and a second member computer memory such that the blockchain computer system limits control over the first portion of the first blockchain-transferable record of the first private computer system user transferable object to only the second member module; in response to validation of the second request, commit the second transfer of the first portion of the first blockchain-transferable record of the first private computer system user transferable object from the first address to the second address on the blockchain computer system such that the blockchain computer system limits control over the first portion first blockchain-transferable record of the first private computer system user transferable object at the second address on the blockchain computer system to only the second member module; circulate and validate a third request from the second member module for a third transfer of a portion of the first private computer system user transferable object from the second account in the private computer system under control of the trustee module to a third account in the private computer system under control of the second member module and to disable a corresponding portion of the first portion of the first blockchain-transferable record of the first private computer system user transferable object in the blockchain computer system such that the corresponding portion of the first portion of the first blockchain-transferable record of the first private computer system user transferable object can no longer be transferred; validate the third request and disable the corresponding portion of the first portion of the first blockchain-transferable record of the first private computer system user transferable object in the blockchain computer system such the corresponding portion of the first portion of the first blockchain-transferable record of the first private computer system user transferable object can no longer be transferred; wherein a trustee computer memory comprises the trustee module and wherein a trustee computer processor is to execute the trustee module and is to thereby: observe validation of the third request and disablement of the corresponding portion of the first portion of the first blockchain-transferable record of the first private computer system user transferable object, and, in response thereto, is to transfer the portion of the first private computer system user transferable object from the second account in the private computer system under control of the trustee module to the third account in the private computer system under control of the second member module, and request that a remaining portion of the first blockchain-transferable record of the first private computer system user transferable object remaining after transfer of the portion of the first private computer system user transferable object from the second account in the private computer system under control of the trustee module to the third account in the private computer system under control of the second member module be transferred to an address in the blockchain computer system under control of at least one of a blockchain execution module in the plurality of blockchain execution modules, the first member module, the second member module, or the trustee module; wherein the blockchain execution module is further to manage governance of the blockchain computer system according to the consensus algorithm to at least one of: add or remove a proposed member module and a proposed trustee module with permissioned access to the blockchain computer system, add or remove a proposed private computer system to work with the blockchain computer system, or change at least one of program code for the blockchain execution module, the member module, the trustee module, or the consensus algorithm.

Example 2. The system according to Example 1, wherein first member module is further to transfer the first private computer system user transferable object from the first account in the private computer system under control of the first member module to the second account in the private computer system under control of the trustee module.

Example 3. The system according to Example 1, wherein the private computer system is one of a computer software provisioning computer system, a multi-player game computer system, or a bank or financial services computer system and wherein the first private computer system user transferable object comprises at least one of digital asset, a computer software program or access thereto, a credit in the multi-player game computer system, fiat money, or a contractual right or obligation.

Example 4. The system according to Example 1, wherein the trustee module is to access the private computer system, confirm transfer of the first private computer system user transferable object to the second account in the private computer system under control of the trustee module, and is to transmit confirmation that the transfer occurred.

Example 5. The system according to Example 1, wherein at least one of the blockchain execution modules is further to detect a fork in the blockchain computer system and, in response thereto, is to not commit a corresponding proposed blockchain-transferable record of a second private computer system user transferable object as a blockchain-transferable record of the second private computer system user transferable object in the blockchain computer system.

Example 6. The system according to Example 1, wherein the proposed first blockchain-transferable record of the first private computer system user transferable object identifies the first member module with an identity tag constructed from a first public key of the first member module and is signed with a ring signature.

Example 7. The system according to Example 1, wherein the proposed first blockchain-transferable record of the first private computer system user transferable object comprises a number concealed in a homomorphic commitment scheme, wherein the homomorphic commitment scheme hides the number and allows addition and subtraction of the number relative to another number, and wherein the number identifies a quantity of the first private computer system user transferable object.

Example 8. The system according to Example 1, wherein the first private computer system user transferable object earns an interest or is subject to deflation in the second account in the private computer system under control of the trustee module and wherein the remaining portion of the first blockchain-transferable record of the first private computer system user transferable object remaining after transfer the portion of the first private computer system user transferable object from the second account in the private computer system under control of the trustee module to the third account in the private computer system under control of the second member module comprises the interest.

Example 9. The system according to Example 1, wherein private computer system user transferable objects are transferable among accounts of users of a plurality of private computer systems, wherein the trustee module further controls a plurality of accounts at the plurality of private computer systems, and wherein the trustee module further transfers private computer system user transferable objects between more than one of the plurality of private computer systems.

Example 10. The system according to Example 9, wherein transfer of the private computer system user transferable objects between more than one of the plurality of private computer systems occurs with a latency, wherein the trustee module further controls at least one buffer account in at least one of the plurality of private computer systems, wherein the trustee module transfers at least a portion of the private computer system user transferable objects from the at least one buffer account in the at least one of the plurality of private computer systems to a fourth account under the control of a third member module in the at least one of the plurality of private computer systems to enable redemption of blockchain-transferable records corresponding to private computer system user transferable objects without regard to the latency.

Example 11. The system according to Example 1, wherein the proposed first blockchain-transferable record of the first private computer system user transferable object comprises an encrypted account information of the first member module for the first account in the private computer system under control of the first member module.

Example 12. The system according to Example 1, wherein to change at least one of the blockchain execution module, the member module, the trustee module, or the consensus algorithm comprises at least one of to set or modify a level of buffer account of the trustee module at the private computer system, to set or modify an amount of compensation paid to the blockchain execution module, to set or modify a threshold at which trustee module transfers the remaining portion of the first blockchain-transferable record of the first private computer system user transferable object remaining after transfer of the portion of the first private computer system user transferable object from the second account in the private computer system under control of the trustee module to the third account in the private computer system under control of the second member module be transferred to an address in the blockchain computer system under control of at least one of a blockchain execution module in the plurality of blockchain execution modules, the first member module, the second member module, or the trustee module.

Example 13. A computer implemented method to correlate transfer of private computer system user transferable objects with blockchain-transferable records, comprising: with a blockchain execution module, creating a blockchain computer system, wherein immutable changes to the blockchain computer system are only allowed by a blockchain execution module according to a consensus algorithm of the blockchain computer system, wherein execution instances of the blockchain execution module and execution instances of a member module participate in the consensus algorithm by voting; providing a first member module in a first member computer memory and executed by a first member computer processor with permissioned access to the blockchain computer system; circulating and validating a first request from the first member module to record in the blockchain computer system a first transfer of a first private computer system user transferable object from a first account in the private computer system under control of the first member module to a second account in the private computer system under control of a trustee module as a proposed first blockchain-transferable record of the first private computer system user transferable object, wherein the trustee module is to hold in trust the first private computer system user transferable object for any instance of a blockchain execution module, member module, or trustee module with control over at least a portion of a blockchain-transferable record of the first private computer system user transferable object; circulating and validating a confirmation from the trustee module that the first transfer of the first private computer system user transferable object from the first account in the private computer system under control of the first member module to the second account in the private computer system under control of the trustee module occurred; in response to validating the confirmation that the first transfer of the first private computer system user transferable object occurred, committing in the blockchain computer system the proposed first blockchain-transferable record of the first private computer system user transferable object as a first blockchain-transferable record of the first private computer system user transferable object at a first address on the blockchain computer system such that the blockchain computer system limits control over the first blockchain-transferable record of the first private computer system user transferable object to only the first member module; circulating and validating a second request from the first member module for a second transfer of a first portion of the first blockchain-transferable record of the first private computer system user transferable object to a second address on the blockchain computer system associated with a second member module associated with a second member computer processor and a second member computer memory such that the blockchain computer system limits control over the first portion of the first blockchain-transferable record of the first private computer system user transferable object to only the second member module; in response to validating the second request, committing the second transfer of the first portion of the first blockchain-transferable record of the first private computer system user transferable object from the first address to the second address on the blockchain computer system such that the blockchain computer system limits control over the first portion first blockchain-transferable record of the first private computer system user transferable object at the second address on the blockchain computer system to only the second member module; circulating and validating a third request from the second member module for a third transfer of a portion of the first private computer system user transferable object from the second account in the private computer system under control of the trustee module to a third account in the private computer system under control of the second member module and to disable a corresponding portion of the first portion of the first blockchain-transferable record of the first private computer system user transferable object in the blockchain computer system such that the corresponding portion of the first portion of the first blockchain-transferable record of the first private computer system user transferable object can no longer be transferred; validating the third request and disabling the corresponding portion of the first portion of the first blockchain-transferable record of the first private computer system user transferable object in the blockchain computer system such the corresponding portion of the first portion of the first blockchain-transferable record of the first private computer system user transferable object can no longer be transferred; with the trustee module, observing validation of the third request and disablement of the corresponding portion of the first portion of the first blockchain-transferable record of the first private computer system user transferable object, and, in response thereto, transferring the portion of the first private computer system user transferable object from the second account in the private computer system under control of the trustee module to the third account in the private computer system under control of the second member module, and requesting that a remaining portion of the first blockchain-transferable record of the first private computer system user transferable object remaining after transfer of the portion of the first private computer system user transferable object from the second account in the private computer system under control of the trustee module to the third account in the private computer system under control of the second member module be transferred to an address in the blockchain computer system under control of at least one of a blockchain execution module in the plurality of blockchain execution modules, the first member module, the second member module, or the trustee module; and further comprising managing governance of the blockchain computer system according to the consensus algorithm to at least one of: add or remove a proposed member module and a proposed trustee module with permissioned access to the blockchain computer system, add or remove a proposed private computer system to work with the blockchain computer system, or change at least one of program code for the blockchain execution module, the member module, the trustee module, or the consensus algorithm.

Example 14. The method according to Example 13, further comprising, with the first member module, transferring the first private computer system user transferable object from the first account in the private computer system under control of the first member module to the second account in the private computer system under control of the trustee module.

Example 15. The method according to Example 13, wherein the private computer system is one of a computer software provisioning computer system, a multi-player game computer system, or a bank or financial services computer system and wherein the first private computer system user transferable object comprises at least one of digital asset, a computer software program or access thereto, a credit in the multi-player game computer system, fiat money, or a contractual right or obligation.

Example 16. The method according to Example 13, further comprising, with the trustee module, accessing the private computer system, confirming transfer of the first private computer system user transferable object to the second account in the private computer system under control of the trustee module, and transmitting confirmation to the blockchain computer system that the transfer occurred.

Example 17. The method according to Example 13, further comprising, with the blockchain execution module, detecting a fork in the blockchain computer system and, in response thereto, not committing a corresponding proposed blockchain-transferable record of a second private computer system user transferable object as a blockchain-transferable record of the second private computer system user transferable object in the blockchain computer system.

Example 18. The method according to Example 13, wherein the proposed first blockchain-transferable record of the first private computer system user transferable object identifies the first member module with an identity tag constructed from a first public key of the first member module and signing the proposed first blockchain-transferable record of the first private computer system user transferable object with a ring signature.

Example 19. The method according to Example 13, wherein the proposed first blockchain-transferable record of the first private computer system user transferable object comprises a number concealed in a homomorphic commitment scheme, wherein the homomorphic commitment scheme hides the number and allows addition and subtraction of the number relative to another number, and wherein the number identifies a quantity of the first private computer system user transferable object.

Example 20. The method according to Example 13, wherein the first private computer system user transferable object earns an interest or is subject to deflation in the second account in the private computer system under control of the trustee module and wherein the remaining portion of the first blockchain-transferable record of the first private computer system user transferable object remaining after transfer the portion of the first private computer system user transferable object from the second account in the private computer system under control of the trustee module to the third account in the private computer system under control of the second member module comprises the interest.

Example 21. The method according to Example 13, wherein private computer system user transferable objects are transferable among accounts of users of a plurality of private computer systems, wherein the trustee module further controls a plurality of accounts at the plurality of private computer systems, and further comprising, with the trustee module, transferring private computer system user transferable objects between more than one of the plurality of private computer systems.

Example 22. The method according to Example 21, wherein transferring of the private computer system user transferable objects between more than one of the plurality of private computer systems occurs with a latency, wherein the trustee module further controls at least one buffer account in at least one of the plurality of private computer systems, and further comprising, with the trustee module, transferring at least a portion of the private computer system user transferable objects from the at least one buffer account in the at least one of the plurality of private computer systems to a fourth account under the control of a third member module in the at least one of the plurality of private computer systems to enable redemption of blockchain-transferable records corresponding to private computer system user transferable objects without regard to the latency.

Example 23. The method according to Example 13, wherein the proposed first blockchain-transferable record of the first private computer system user transferable object comprises an encrypted account information of the first member module for the first account in the private computer system under control of the first member module.

Example 24. The method according to Example 13, wherein changing at least one of the blockchain execution module, the member module, the trustee module, or the consensus algorithm comprises at least one of setting or modifying a level of buffer account of the trustee module at the private computer system, setting or modifying an amount of compensation paid to the blockchain execution module, setting or modifying a threshold at which trustee module transfers the remaining portion of the first blockchain-transferable record of the first private computer system user transferable object remaining after transfer of the portion of the first private computer system user transferable object from the second account in the private computer system under control of the trustee module to the third account in the private computer system under control of the second member module be transferred to an address in the blockchain computer system under control of at least one of a blockchain execution module in the plurality of blockchain execution modules, the first member module, the second member module, or the trustee module.

Example 25. A computer apparatus to correlate transfer of private computer system user transferable objects with blockchain-transferable records, comprising: with a blockchain execution module, means to create a blockchain computer system, wherein immutable changes to the blockchain computer system are only allowed by a blockchain execution module according to a consensus algorithm of the blockchain computer system, wherein execution instances of the blockchain execution module and execution instances of a member module participate in the consensus algorithm by voting; means to provide a first member module in a first member computer memory and executed by a first member computer processor with permissioned access to the blockchain computer system; means to circulate and validate a first request from the first member module to record in the blockchain computer system a first transfer of a first private computer system user transferable object from a first account in the private computer system under control of the first member module to a second account in the private computer system under control of a trustee module as a proposed first blockchain-transferable record of the first private computer system user transferable object, wherein the trustee module comprises means to hold in trust the first private computer system user transferable object for any instance of a blockchain execution module, member module, or trustee module with control over at least a portion of a blockchain-transferable record of the first private computer system user transferable object; means to circulate and validate a confirmation from the trustee module that the first transfer of the first private computer system user transferable object from the first account in the private computer system under control of the first member module to the second account in the private computer system under control of the trustee module occurred; in response to validation that the confirmation that the first transfer of the first private computer system user transferable object occurred, means to commit in the blockchain computer system the proposed first blockchain-transferable record of the first private computer system user transferable object as a first blockchain-transferable record of the first private computer system user transferable object at a first address on the blockchain computer system such that the blockchain computer system limits control over the first blockchain-transferable record of the first private computer system user transferable object to only the first member module; means to circulate and validate a second request from the first member module for a second transfer of a first portion of the first blockchain-transferable record of the first private computer system user transferable object to a second address on the blockchain computer system associated with a second member module associated with a second member computer processor and a second member computer memory such that the blockchain computer system limits control over the first portion of the first blockchain-transferable record of the first private computer system user transferable object to only the second member module; in response to validation of the second request, means to commit the second transfer of the first portion of the first blockchain-transferable record of the first private computer system user transferable object from the first address to the second address on the blockchain computer system such that the blockchain computer system limits control over the first portion first blockchain-transferable record of the first private computer system user transferable object at the second address on the blockchain computer system to only the second member module; means to circulate and validate a third request from the second member module for a third transfer of a portion of the first private computer system user transferable object from the second account in the private computer system under control of the trustee module to a third account in the private computer system under control of the second member module and to disable a corresponding portion of the first portion of the first blockchain-transferable record of the first private computer system user transferable object in the blockchain computer system such that the corresponding portion of the first portion of the first blockchain-transferable record of the first private computer system user transferable object can no longer be transferred; means to validate the third request and disable the corresponding portion of the first portion of the first blockchain-transferable record of the first private computer system user transferable object in the blockchain computer system such the corresponding portion of the first portion of the first blockchain-transferable record of the first private computer system user transferable object can no longer be transferred; with the trustee module, means to observe validation of the third request and disablement of the corresponding portion of the first portion of the first blockchain-transferable record of the first private computer system user transferable object, and, in response thereto, means to transfer the portion of the first private computer system user transferable object from the second account in the private computer system under control of the trustee module to the third account in the private computer system under control of the second member module, and means to request that a remaining portion of the first blockchain-transferable record of the first private computer system user transferable object remaining after transfer of the portion of the first private computer system user transferable object from the second account in the private computer system under control of the trustee module to the third account in the private computer system under control of the second member module be transferred to an address in the blockchain computer system under control of at least one of a blockchain execution module in the plurality of blockchain execution modules, the first member module, the second member module, or the trustee module; further comprising means to manage governance of the blockchain computer system according to the consensus algorithm to at least one of: add or remove a proposed member module and a proposed trustee module with permissioned access to the blockchain computer system, add or remove a proposed private computer system to work with the blockchain computer system, and change at least one of program code for the blockchain execution module, the member module, the trustee module, or the consensus algorithm.

Example 26. The computer apparatus according to Example 25, further comprising, with the first member module, transferring the first private computer system user transferable object from the first account in the private computer system under control of the first member module to the second account in the private computer system under control of the trustee module.

Example 27. The computer apparatus according to Example 25, wherein the private computer system is one of a computer software provisioning computer system, a multi-player game computer system, or a bank or financial services computer system and wherein the first private computer system user transferable object comprises at least one of digital asset, a computer software program or access thereto, a credit in the multi-player game computer system, fiat money, or a contractual right or obligation.

Example 28. The computer apparatus according to Example 25, further comprising, with the trustee module, means to access the private computer system, confirm transfer of the first private computer system user transferable object to the second account in the private computer system under control of the trustee module, and transmit confirmation to the blockchain computer system that the transfer occurred.

Example 29. The computer apparatus according to Example 25, further comprising, with the blockchain execution module, means to detect a fork in the blockchain computer system and, in response thereto, to not commit a corresponding proposed blockchain-transferable record of a second private computer system user transferable object as a blockchain-transferable record of the second private computer system user transferable object in the blockchain computer system.

Example 30. The computer apparatus according to Example 25, wherein the proposed first blockchain-transferable record of the first private computer system user transferable object identifies the first member module with an identity tag constructed from a first public key of the first member module and signing the proposed first blockchain-transferable record of the first private computer system user transferable object with a ring signature.

Example 31. The computer apparatus according to Example 25, wherein the proposed first blockchain-transferable record of the first private computer system user transferable object comprises a number concealed in a homomorphic commitment scheme, wherein the homomorphic commitment scheme hides the number and allows addition and subtraction of the number relative to another number, and wherein the number identifies a quantity of the first private computer system user transferable object.

Example 32. The computer apparatus according to Example 25, wherein the first private computer system user transferable object earns an interest or is subject to deflation in the second account in the private computer system under control of the trustee module and wherein the remaining portion of the first blockchain-transferable record of the first private computer system user transferable object remaining after transfer the portion of the first private computer system user transferable object from the second account in the private computer system under control of the trustee module to the third account in the private computer system under control of the second member module comprises the interest.

Example 33. The computer apparatus according to Example 25, wherein private computer system user transferable objects are transferable among accounts of users of a plurality of private computer systems, wherein the trustee module further controls a plurality of accounts at the plurality of private computer systems, and further comprising, with the trustee module, means to transfer private computer system user transferable objects between more than one of the plurality of private computer systems.

Example 34. The computer apparatus according to Example 33, wherein transferring the private computer system user transferable objects between more than one of the plurality of private computer systems occurs with a latency, wherein the trustee module further controls at least one buffer account in at least one of the plurality of private computer systems, and further comprising, with the trustee module, means to transfer at least a portion of the private computer system user transferable objects from the at least one buffer account in the at least one of the plurality of private computer systems to a fourth account under the control of a third member module in the at least one of the plurality of private computer systems to enable redemption of blockchain-transferable records corresponding to private computer system user transferable objects without regard to the latency.

Example 35. The computer apparatus according to Example 25, wherein the proposed first blockchain-transferable record of the first private computer system user transferable object comprises an encrypted account information of the first member module for the first account in the private computer system under control of the first member module.

Example 36. The computer apparatus according to Example 25, wherein to change at least one of the blockchain execution module, the member module, the trustee module, or the consensus algorithm comprises means to at least one of set or modify a level of buffer account of the trustee module at the private computer system, set or modify an amount of compensation paid to the blockchain execution module, set or modify a threshold at which trustee module transfers the remaining portion of the first blockchain-transferable record of the first private computer system user transferable object remaining after transfer of the portion of the first private computer system user transferable object from the second account in the private computer system under control of the trustee module to the third account in the private computer system under control of the second member module be transferred to an address in the blockchain computer system under control of at least one of a blockchain execution module in the plurality of blockchain execution modules, the first member module, the second member module, or the trustee module.

Example 37. One or more computer-readable media comprising instructions that cause one or more computer devices, in response to execution of the instructions by processors of the computer devices, to: with a blockchain execution module, create a blockchain computer system, wherein immutable changes to the blockchain computer system are only allowed by a blockchain execution module according to a consensus algorithm of the blockchain computer system, wherein execution instances of the blockchain execution module and execution instances of a member module participate in the consensus algorithm by voting; provide a first member module in a first member computer memory and executed by a first member computer processor with permissioned access to the blockchain computer system; circulate and validate a first request from the first member module to record in the blockchain computer system a first transfer of a first private computer system user transferable object from a first account in the private computer system under control of the first member module to a second account in the private computer system under control of a trustee module as a proposed first blockchain-transferable record of the first private computer system user transferable object, wherein the trustee module comprises means to hold in trust the first private computer system user transferable object for any instance of a blockchain execution module, member module, or trustee module with control over at least a portion of a blockchain-transferable record of the first private computer system user transferable object; circulate and validate a confirmation from the trustee module that the first transfer of the first private computer system user transferable object from the first account in the private computer system under control of the first member module to the second account in the private computer system under control of the trustee module occurred; in response to validation that the confirmation that the first transfer of the first private computer system user transferable object occurred, commit in the blockchain computer system the proposed first blockchain-transferable record of the first private computer system user transferable object as a first blockchain-transferable record of the first private computer system user transferable object at a first address on the blockchain computer system such that the blockchain computer system limits control over the first blockchain-transferable record of the first private computer system user transferable object to only the first member module; circulate and validate a second request from the first member module for a second transfer of a first portion of the first blockchain-transferable record of the first private computer system user transferable object to a second address on the blockchain computer system associated with a second member module associated with a second member computer processor and a second member computer memory such that the blockchain computer system limits control over the first portion of the first blockchain-transferable record of the first private computer system user transferable object to only the second member module; in response to validation of the second request, commit the second transfer of the first portion of the first blockchain-transferable record of the first private computer system user transferable object from the first address to the second address on the blockchain computer system such that the blockchain computer system limits control over the first portion first blockchain-transferable record of the first private computer system user transferable object at the second address on the blockchain computer system to only the second member module; circulate and validate a third request from the second member module for a third transfer of a portion of the first private computer system user transferable object from the second account in the private computer system under control of the trustee module to a third account in the private computer system under control of the second member module and to disable a corresponding portion of the first portion of the first blockchain-transferable record of the first private computer system user transferable object in the blockchain computer system such that the corresponding portion of the first portion of the first blockchain-transferable record of the first private computer system user transferable object can no longer be transferred; validate the third request and disable the corresponding portion of the first portion of the first blockchain-transferable record of the first private computer system user transferable object in the blockchain computer system such the corresponding portion of the first portion of the first blockchain-transferable record of the first private computer system user transferable object can no longer be transferred; with the trustee module, observe validation of the third request and disablement of the corresponding portion of the first portion of the first blockchain-transferable record of the first private computer system user transferable object, and, in response thereto, transfer the portion of the first private computer system user transferable object from the second account in the private computer system under control of the trustee module to the third account in the private computer system under control of the second member module, and request that a remaining portion of the first blockchain-transferable record of the first private computer system user transferable object remaining after transfer of the portion of the first private computer system user transferable object from the second account in the private computer system under control of the trustee module to the third account in the private computer system under control of the second member module be transferred to an address in the blockchain computer system under control of at least one of a blockchain execution module in the plurality of blockchain execution modules, the first member module, the second member module, or the trustee module; further comprising to manage governance of the blockchain computer system according to the consensus algorithm to at least one of: add or remove a proposed member module and a proposed trustee module with permissioned access to the blockchain computer system, add or remove a proposed private computer system to work with the blockchain computer system, and change at least one of program code for the blockchain execution module, the member module, the trustee module, or the consensus algorithm.

Example 38. The computer readable media according to Example 37, wherein the computer readable media are further to cause the first member module to transfer the first private computer system user transferable object from the first account in the private computer system under control of the first member module to the second account in the private computer system under control of the trustee module.

Example 39. The computer readable media according to Example 37, wherein the private computer system is one of a computer software provisioning computer system, a multi-player game computer system, or a bank or financial services computer system and wherein the first private computer system user transferable object comprises at least one of digital asset, a computer software program or access thereto, a credit in the multi-player game computer system, fiat money, or a contractual right or obligation.

Example 40. The computer readable media according to Example 37, wherein the computer readable media are further to cause the trustee module to access the private computer system, confirm transfer of the first private computer system user transferable object to the second account in the private computer system under control of the trustee module, and transmit confirmation to the blockchain computer system that the transfer occurred.

Example 41. The computer readable media according to Example 37, wherein the computer readable media are further to cause the blockchain execution module to detect a fork in the blockchain computer system and, in response thereto, to not commit a corresponding proposed blockchain-transferable record of a second private computer system user transferable object as a blockchain-transferable record of the second private computer system user transferable object in the blockchain computer system.

Example 42. The computer readable media according to Example 37, wherein the proposed first blockchain-transferable record of the first private computer system user transferable object identifies the first member module with an identity tag constructed from a first public key of the first member module and wherein the computer readable media are further to cause the blockchain module to sign the proposed first blockchain-transferable record of the first private computer system user transferable object with a ring signature.

Example 43. The computer readable media according to Example 37, wherein the proposed first blockchain-transferable record of the first private computer system user transferable object comprises a number concealed in a homomorphic commitment scheme, wherein the homomorphic commitment scheme hides the number and allows addition and subtraction of the number relative to another number, and wherein the number identifies a quantity of the first private computer system user transferable object.

Example 44. The computer readable media according to Example 37, wherein the first private computer system user transferable object earns an interest or is subject to deflation in the second account in the private computer system under control of the trustee module and wherein the remaining portion of the first blockchain-transferable record of the first private computer system user transferable object remaining after transfer the portion of the first private computer system user transferable object from the second account in the private computer system under control of the trustee module to the third account in the private computer system under control of the second member module comprises the interest.

Example 45. The computer readable media according to Example 37, wherein private computer system user transferable objects are transferable among accounts of users of a plurality of private computer systems, wherein the trustee module further controls a plurality of accounts at the plurality of private computer systems, and wherein the computer readable media are further to cause the trustee module to transfer private computer system user transferable objects between more than one of the plurality of private computer systems.

Example 46. The computer readable media according to Example 45, wherein transferring the private computer system user transferable objects between more than one of the plurality of private computer systems occurs with a latency, wherein the trustee module further controls at least one buffer account in at least one of the plurality of private computer systems, and wherein the computer readable media are further to cause the trustee module to transfer at least a portion of the private computer system user transferable objects from the at least one buffer account in the at least one of the plurality of private computer systems to a fourth account under the control of a third member module in the at least one of the plurality of private computer systems to enable redemption of blockchain-transferable records corresponding to private computer system user transferable objects without regard to the latency.

Example 47. The computer readable media according to Example 37, wherein the proposed first blockchain-transferable record of the first private computer system user transferable object comprises an encrypted account information of the first member module for the first account in the private computer system under control of the first member module.

Example 48. The computer readable media according to Example 37, wherein to change at least one of the blockchain execution module, the member module, the trustee module, or the consensus algorithm comprises to at least one of set or modify a level of buffer account of the trustee module at the private computer system, set or modify an amount of compensation paid to the blockchain execution module, set or modify a threshold at which trustee module transfers the remaining portion of the first blockchain-transferable record of the first private computer system user transferable object remaining after transfer of the portion of the first private computer system user transferable object from the second account in the private computer system under control of the trustee module to the third account in the private computer system under control of the second member module be transferred to an address in the blockchain computer system under control of at least one of a blockchain execution module in the plurality of blockchain execution modules, the first member module, the second member module, or the trustee module.

1. A system to correlate transfer of private computer system user transferable objects with blockchain-transferable records, comprising:
a first plurality of computer processors and a first plurality of computer memories of a first plurality of blockchain creation and maintenance computer systems, wherein each of the first plurality of computer memories comprise a blockchain execution module, wherein the first plurality of computer processors are each to separately execute the blockchain execution module and are to thereby:
create a blockchain computer system, wherein immutable changes to the blockchain computer system are only allowed by the blockchain execution module according to a consensus algorithm of the blockchain computer system, wherein execution instances of the blockchain execution module and execution instances of a member module participate in the consensus algorithm by voting;
provide a first member module in a first member computer memory and executed by a first member computer processor with permissioned access to the blockchain computer system;
circulate and validate a first request from the first member module to record in the blockchain computer system a first transfer of a first private computer system user transferable object from a first account in the private computer system under control of the first member module to a second account in the private computer system under control of a trustee module as a proposed first blockchain-transferable record of the first private computer system user transferable object, wherein the trustee module is to hold in trust the first private computer system user transferable object for any instance of a blockchain execution module, member module, or trustee module with control over at least a portion of a blockchain-transferable record of the first private computer system user transferable object;
circulate and validate a confirmation from the trustee module that the first transfer of the first private computer system user transferable object from the first account in the private computer system under control of the first member module to the second account in the private computer system under control of the trustee module occurred;
in response to validation of the confirmation that the first transfer of the first private computer system user transferable object occurred, commit in the blockchain computer system the proposed first blockchain-transferable record of the first private computer system user transferable object as a first blockchain-transferable record of the first private computer system user transferable object, recorded at a first address on the blockchain computer system such that the blockchain computer system limits control over the first blockchain-transferable record of the first private computer system user transferable object to only the first member module;
circulate and validate a second request from the first member module for a second transfer of a first portion of the first blockchain-transferable record of the first private computer system user transferable object to a second address on the blockchain computer system associated with a second member module associated with a second member computer processor and a second member computer memory such that the blockchain computer system limits control over the first portion of the first blockchain-transferable record of the first private computer system user transferable object to only the second member module;
in response to validation of the second request, commit the second transfer of the first portion of the first blockchain-transferable record of the first private computer system user transferable object from the first address to the second address on the blockchain computer system such that the blockchain computer system limits control over the first portion first blockchain-transferable record of the first private computer system user transferable object at the second address on the blockchain computer system to only the second member module;
circulate and validate a third request from the second member module for a third transfer of a portion of the first private computer system user transferable object from the second account in the private computer system under control of the trustee module to a third account in the private computer system under control of the second member module and to disable a corresponding portion of the first portion of the first blockchain-transferable record of the first private computer system user transferable object in the blockchain computer system such that the corresponding portion of the first portion of the first blockchain-transferable record of the first private computer system user transferable object can no longer be transferred;
validate the third request and disable the corresponding portion of the first portion of the first blockchain-transferable record of the first private computer system user transferable object in the blockchain computer system such the corresponding portion of the first portion of the first blockchain-transferable record of the first private computer system user transferable object can no longer be transferred;
wherein a trustee computer memory comprises the trustee module and wherein a trustee computer processor is to execute the trustee module and is to thereby:
observe validation of the third request and disablement of the corresponding portion of the first portion of the first blockchain-transferable record of the first private computer system user transferable object, and, in response thereto, is to
transfer the portion of the first private computer system user transferable object from the second account in the private computer system under control of the trustee module to the third account in the private computer system under control of the second member module, and
request that a remaining portion of the first blockchain-transferable record of the first private computer system user transferable object remaining after transfer of the portion of the first private computer system user transferable object from the second account in the private computer system under control of the trustee module to the third account in the private computer system under control of the second member module be transferred to an address in the blockchain computer system under control of at least one of a blockchain execution module in the plurality of blockchain execution modules, the first member module, the second member module, or the trustee module; wherein
the blockchain execution module is further to manage governance of the blockchain computer system according to the consensus algorithm to at least one of:
add or remove a proposed member module and a proposed trustee module with permissioned access to the blockchain computer system,
add or remove a proposed private computer system to work with the blockchain computer system, or
change at least one of program code for the blockchain execution module, the member module, the trustee module, or the consensus algorithm.

2. The system according to claim 1, wherein first member module is further to transfer the first private computer system user transferable object from the first account in the private computer system under control of the first member module to the second account in the private computer system under control of the trustee module.

3. The system according to claim 1, wherein the private computer system is one of a computer software provisioning computer system, a multi-player game computer system, or a bank or financial services computer system and wherein the first private computer system user transferable object comprises at least one of digital asset, a computer software program or access thereto, a credit in the multi-player game computer system, fiat money, or a contractual right or obligation.

4. The system according to claim 1, wherein the trustee module is to access the private computer system, confirm transfer of the first private computer system user transferable object to the second account in the private computer system under control of the trustee module, and is to transmit confirmation that the transfer occurred.

5. The system according to claim 1, wherein at least one of the blockchain execution modules is further to detect a fork in the blockchain computer system and, in response thereto, is to not commit a corresponding proposed blockchain-transferable record of a second private computer system user transferable object as a blockchain-transferable record of the second private computer system user transferable object in the blockchain computer system.

6. The system according to claim 1, wherein the proposed first blockchain-transferable record of the first private computer system user transferable object identifies the first member module with an identity tag constructed from a first public key of the first member module and is signed with a ring signature.

7. The system according to claim 1, wherein the proposed first blockchain-transferable record of the first private computer system user transferable object comprises a number concealed in a homomorphic commitment scheme, wherein the homomorphic commitment scheme hides the number and allows addition and subtraction of the number relative to another number, and wherein the number identifies a quantity of the first private computer system user transferable object.

8. The system according to claim 1, wherein the first private computer system user transferable object earns an interest or is subject to deflation in the second account in the private computer system under control of the trustee module and wherein the remaining portion of the first blockchain-transferable record of the first private computer system user transferable object remaining after transfer the portion of the first private computer system user transferable object from the second account in the private computer system under control of the trustee module to the third account in the private computer system under control of the second member module comprises the interest.

9. The system according to claim 1, wherein private computer system user transferable objects are transferable among accounts of users of a plurality of private computer systems, wherein the trustee module further controls a plurality of accounts at the plurality of private computer systems, and wherein the trustee module further transfers private computer system user transferable objects between more than one of the plurality of private computer systems.

10. The system according to claim 9, wherein transfer of the private computer system user transferable objects between more than one of the plurality of private computer systems occurs with a latency, wherein the trustee module further controls at least one buffer account in at least one of the plurality of private computer systems, wherein the trustee module transfers at least a portion of the private computer system user transferable objects from the at least one buffer account in the at least one of the plurality of private computer systems to a fourth account under the control of a third member module in the at least one of the plurality of private computer systems to enable redemption of blockchain-transferable records corresponding to private computer system user transferable objects without regard to the latency.

11. The system according to claim 1, wherein the proposed first blockchain-transferable record of the first private computer system user transferable object comprises an encrypted account information of the first member module for the first account in the private computer system under control of the first member module.

12. The system according to claim 1, wherein to change at least one of the blockchain execution module, the member module, the trustee module, or the consensus algorithm comprises at least one of to set or modify a level of buffer account of the trustee module at the private computer system, to set or modify an amount of compensation paid to the blockchain execution module, to set or modify a threshold at which trustee module transfers the remaining portion of the first blockchain-transferable record of the first private computer system user transferable object remaining after transfer of the portion of the first private computer system user transferable object from the second account in the private computer system under control of the trustee module to the third account in the private computer system under control of the second member module be transferred to an address in the blockchain computer system under control of at least one of a blockchain execution module in the plurality of blockchain execution modules, the first member module, the second member module, or the trustee module.

13. A computer implemented method to correlate transfer of private computer system user transferable objects with blockchain-transferable records, comprising:
with a blockchain execution module, creating a blockchain computer system, wherein immutable changes to the blockchain computer system are only allowed by a blockchain execution module according to a consensus algorithm of the blockchain computer system, wherein execution instances of the blockchain execution module and execution instances of a member module participate in the consensus algorithm by voting;
providing a first member module in a first member computer memory and executed by a first member computer processor with permissioned access to the blockchain computer system;
circulating and validating a first request from the first member module to record in the blockchain computer system a first transfer of a first private computer system user transferable object from a first account in the private computer system under control of the first member module to a second account in the private computer system under control of a trustee module as a proposed first blockchain-transferable record of the first private computer system user transferable object, wherein the trustee module is to hold in trust the first private computer system user transferable object for any instance of a blockchain execution module, member module, or trustee module with control over at least a portion of a blockchain-transferable record of the first private computer system user transferable object;
circulating and validating a confirmation from the trustee module that the first transfer of the first private computer system user transferable object from the first account in the private computer system under control of the first member module to the second account in the private computer system under control of the trustee module occurred;
in response to validating the confirmation that the first transfer of the first private computer system user transferable object occurred, committing in the blockchain computer system the proposed first blockchain-transferable record of the first private computer system user transferable object as a first blockchain-transferable record of the first private computer system user transferable object at a first address on the blockchain computer system such that the blockchain computer system limits control over the first blockchain-transferable record of the first private computer system user transferable object to only the first member module;
circulating and validating a second request from the first member module for a second transfer of a first portion of the first blockchain-transferable record of the first private computer system user transferable object to a second address on the blockchain computer system associated with a second member module associated with a second member computer processor and a second member computer memory such that the blockchain computer system limits control over the first portion of the first blockchain-transferable record of the first private computer system user transferable object to only the second member module;
in response to validating the second request, committing the second transfer of the first portion of the first blockchain-transferable record of the first private computer system user transferable object from the first address to the second address on the blockchain computer system such that the blockchain computer system limits control over the first portion first blockchain-transferable record of the first private computer system user transferable object at the second address on the blockchain computer system to only the second member module;
circulating and validating a third request from the second member module for a third transfer of a portion of the first private computer system user transferable object from the second account in the private computer system under control of the trustee module to a third account in the private computer system under control of the second member module and to disable a corresponding portion of the first portion of the first blockchain-transferable record of the first private computer system user transferable object in the blockchain computer system such that the corresponding portion of the first portion of the first blockchain-transferable record of the first private computer system user transferable object can no longer be transferred;
validating the third request and disabling the corresponding portion of the first portion of the first blockchain-transferable record of the first private computer system user transferable object in the blockchain computer system such the corresponding portion of the first portion of the first blockchain-transferable record of the first private computer system user transferable object can no longer be transferred;
with the trustee module, observing validation of the third request and disablement of the corresponding portion of the first portion of the first blockchain-transferable record of the first private computer system user transferable object, and, in response thereto,
transferring the portion of the first private computer system user transferable object from the second account in the private computer system under control of the trustee module to the third account in the private computer system under control of the second member module, and
requesting that a remaining portion of the first blockchain-transferable record of the first private computer system user transferable object remaining after transfer of the portion of the first private computer system user transferable object from the second account in the private computer system under control of the trustee module to the third account in the private computer system under control of the second member module be transferred to an address in the blockchain computer system under control of at least one of a blockchain execution module in the plurality of blockchain execution modules, the first member module, the second member module, or the trustee module; and further comprising
managing governance of the blockchain computer system according to the consensus algorithm to at least one of:
add or remove a proposed member module and a proposed trustee module with permissioned access to the blockchain computer system,
add or remove a proposed private computer system to work with the blockchain computer system, or
change at least one of program code for the blockchain execution module, the member module, the trustee module, or the consensus algorithm.

14. The method according to claim 13, further comprising, with the first member module, transferring the first private computer system user transferable object from the first account in the private computer system under control of the first member module to the second account in the private computer system under control of the trustee module.

15. The method according to claim 13, further comprising, with the trustee module, accessing the private computer system, confirming transfer of the first private computer system user transferable object to the second account in the private computer system under control of the trustee module, and transmitting confirmation to the blockchain computer system that the transfer occurred.

16. The method according to claim 13, further comprising, with the blockchain execution module, detecting a fork in the blockchain computer system and, in response thereto, not committing a corresponding proposed blockchain-transferable record of a second private computer system user transferable object as a blockchain-transferable record of the second private computer system user transferable object in the blockchain computer system.

17. A computer apparatus to correlate transfer of private computer system user transferable objects with blockchain-transferable records, comprising:
with a blockchain execution module, means to create a blockchain computer system, wherein immutable changes to the blockchain computer system are only allowed by a blockchain execution module according to a consensus algorithm of the blockchain computer system, wherein execution instances of the blockchain execution module and execution instances of a member module participate in the consensus algorithm by voting;
means to provide a first member module in a first member computer memory and executed by a first member computer processor with permissioned access to the blockchain computer system;
means to circulate and validate a first request from the first member module to record in the blockchain computer system a first transfer of a first private computer system user transferable object from a first account in the private computer system under control of the first member module to a second account in the private computer system under control of a trustee module as a proposed first blockchain-transferable record of the first private computer system user transferable object, wherein the trustee module comprises means to hold in trust the first private computer system user transferable object for any instance of a blockchain execution module, member module, or trustee module with control over at least a portion of a blockchain-transferable record of the first private computer system user transferable object;
means to circulate and validate a confirmation from the trustee module that the first transfer of the first private computer system user transferable object from the first account in the private computer system under control of the first member module to the second account in the private computer system under control of the trustee module occurred;
in response to validation that the confirmation that the first transfer of the first private computer system user transferable object occurred, means to commit in the blockchain computer system the proposed first blockchain-transferable record of the first private computer system user transferable object as a first blockchain-transferable record of the first private computer system user transferable object at a first address on the blockchain computer system such that the blockchain computer system limits control over the first blockchain-transferable record of the first private computer system user transferable object to only the first member module;
means to circulate and validate a second request from the first member module for a second transfer of a first portion of the first blockchain-transferable record of the first private computer system user transferable object to a second address on the blockchain computer system associated with a second member module associated with a second member computer processor and a second member computer memory such that the blockchain computer system limits control over the first portion of the first blockchain-transferable record of the first private computer system user transferable object to only the second member module;
in response to validation of the second request, means to commit the second transfer of the first portion of the first blockchain-transferable record of the first private computer system user transferable object from the first address to the second address on the blockchain computer system such that the blockchain computer system limits control over the first portion first blockchain-transferable record of the first private computer system user transferable object at the second address on the blockchain computer system to only the second member module;
means to circulate and validate a third request from the second member module for a third transfer of a portion of the first private computer system user transferable object from the second account in the private computer system under control of the trustee module to a third account in the private computer system under control of the second member module and to disable a corresponding portion of the first portion of the first blockchain-transferable record of the first private computer system user transferable object in the blockchain computer system such that the corresponding portion of the first portion of the first blockchain-transferable record of the first private computer system user transferable object can no longer be transferred;
means to validate the third request and disable the corresponding portion of the first portion of the first blockchain-transferable record of the first private computer system user transferable object in the blockchain computer system such the corresponding portion of the first portion of the first blockchain-transferable record of the first private computer system user transferable object can no longer be transferred;
with the trustee module, means to observe validation of the third request and disablement of the corresponding portion of the first portion of the first blockchain-transferable record of the first private computer system user transferable object, and, in response thereto,
means to transfer the portion of the first private computer system user transferable object from the second account in the private computer system under control of the trustee module to the third account in the private computer system under control of the second member module, and
means to request that a remaining portion of the first blockchain-transferable record of the first private computer system user transferable object remaining after transfer of the portion of the first private computer system user transferable object from the second account in the private computer system under control of the trustee module to the third account in the private computer system under control of the second member module be transferred to an address in the blockchain computer system under control of at least one of a blockchain execution module in the plurality of blockchain execution modules, the first member module, the second member module, or the trustee module; further comprising
means to manage governance of the blockchain computer system according to the consensus algorithm to at least one of:
add or remove a proposed member module and a proposed trustee module with permissioned access to the blockchain computer system,
add or remove a proposed private computer system to work with the blockchain computer system, and
change at least one of program code for the blockchain execution module, the member module, the trustee module, or the consensus algorithm.

18. The computer apparatus according to claim 25, further comprising, with the first member module, transferring the first private computer system user transferable object from the first account in the private computer system under control of the first member module to the second account in the private computer system under control of the trustee module.

19. The computer apparatus according to claim 25, further comprising, with the trustee module, means to access the private computer system, confirm transfer of the first private computer system user transferable object to the second account in the private computer system under control of the trustee module, and transmit confirmation to the blockchain computer system that the transfer occurred.

20. The computer apparatus according to claim 25, further comprising, with the blockchain execution module, means to detect a fork in the blockchain computer system and, in response thereto, to not commit a corresponding proposed blockchain-transferable record of a second private computer system user transferable object as a blockchain-transferable record of the second private computer system user transferable object in the blockchain computer system.
